(19) United States
(12) Patent Application Publication
(10) Pub. No.: US 2005/0219578 A1
(43) Pub. Date: Oct. 6, 2005

(54) Image processing apparatus, image processing method, and computer program product

(76) Inventors: Yasushi Hiraoka, Matsumoto-shi (JP); Teruhito Kojima, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/034,087

(22) Filed: Jan. 11, 2005

(30) Foreign Application Priority Data
Jan. 13, 2004 (JP) 2004-4945
Jan. 23, 2004 (JP) 2004-15248
Jan. 26, 2004 (JP) 2004-17000

(51) Int. Cl. G06F 15/00; G06K 9/00

(52) U.S. Cl. 358/1.9; 358/1.14

(57) ABSTRACT

In a computer system of the invention, a menu button BT2 ‘Retouching Pre-Process’ clicked to activate a retouching pre-process and a menu button BT3 ‘Retouching Post-Process’ clicked to activate a retouching post-process are vertically downward aligned in a processing menu window MN corresponding to an order of operation procedure. The retouching pre-process includes 16-bit color support image processing options, for example, ‘brightness adjustment’ and ‘contrast adjustment’. The retouching post-process includes 8-bit color support image processing options, for example, ‘unsharp mask’ and ‘light irradiation’. When the operator clicks the menu button BT2 ‘Retouching Pre-process’ to execute any image processing option included in the retouching pre-process after execution of any image processing option included in the retouching post-process with regard to input image data, the computer system opens a message box to notify the operator of prohibition of a return to the retouching pre-process. The computer system thus effectively prevents execution of any image processing option included in the retouching pre-process after execution of any image processing option included in the retouching post-process. This arrangement desirably prevents potential deterioration of the picture quality in a retouching process that includes both the 16-bit color support image processing and the 8-bit color support image processing.

### BACKGROUND OF THE INVENTION

1. Field of the Invention

The present invention relates to a technique of retouching image data.

2. Description of the Related Art

Image retouching software executed on the computer is used to readily adjust the brightness and the contrast of image data (see, For example, JP 2000-331180A). This known technique, however, undesirably deteriorates the picture quality of a resulting image by such adjustment. Recently developed retouching software internally handles image data as greater tone bit number data and executes image processing with expression of 16 bits per pixel of image data (48 bits per pixel for RGB) that corresponds to 65536 tones, instead of image processing with expression of 8 bits per pixel of image data (24 bits per pixel for RGB) that corresponds to 256 tones. The 16-bit image processing relieves deterioration of the picture quality.

The image retouching process sequentially executes a series of image processing that include adjustment of the brightness, adjustment of the contrast, and adjustment of the saturation. The whole series of image processing does not handle image data as 16-bit tone data, since a printer used for the final output generally has 8-bit inputs and the 16-bit image processing undesirably lowers the processing speed and expands consumption of the memory resource. Only the image processing that requires the high accuracy is thus designed to handle image data as 16-bit tone data, while the residual image processing is designed to handle image data as 8-bit tone data.

The prior art technique can not, however, take advantage of the subsequent image processing for the 16-bit tone data once the image data is handled as 8-bit tone data. Processing the image data as the 8-bit tone data decreases the volume of image information to 8 bits. The subsequent image processing of handling the image data as 16-bit tone data does not increase the volume of image information.

### SUMMARY OF THE INVENTION

The object of the invention is thus to prevent potential deterioration of the picture quality in a retouching process that includes both image processing of handling image data as 16-bit tone data and image processing of handling image data as 8-bit tone data.

In order to attain at least part of the above and the other related objects, the present invention is directed to a first image processing apparatus that sequentially executes at least two image processing options, which are selected among multiple image processing options provided in advance, with regard to input image data to retouch the input image data, wherein the multiple image processing options are designed to process image data of different tone bit numbers expressible in each pixel. The first image processing apparatus includes: a classification storage module that stores in advance a result of classification of the multiple image processing options into plural groups by the tone bit number; a tone bit number detection module that, in response to an execution instruction of a next image processing option after execution of a specific image processing option with regard to the input image data, refers to the result of classification stored in the classification storage module and determines whether the next image processing option is supposed to process image data of a greater tone bit number than a tone bit number of image data processed by the specific image processing option; and an image processing prohibition module that prohibits execution of the next image processing option when the tone bit number detection module determines that the next image processing option is supposed to process the image data of the greater tone bit number.

In the first image processing apparatus of the invention, when the tone bit number detection module determines that the next image processing option to be executed after execution of the specific image processing option with regard to the input image data handles the image data having the greater tone bit number than the tone bit number of the specific image processing option, the image processing prohibition module prohibits execution of the next image processing option.

The operator is only allowed to collectively execute image processing options for the image data of the greater tone bit number and then execute image processing options for the image data of the smaller tone bit number. This structure of the second image processing apparatus prohibits image data converted from the smaller tone bit number from going through any subsequent image processing option grouped into the greater tone bit number. The image processing for the greater tone bit number thus ensures the expected performances. This arrangement desirably prevents potential deterioration of the picture quality.

In one preferable embodiment of the invention, the first image processing apparatus further includes: a display module; a first display control module that displays plural group switches respectively corresponding to the plural groups of classification stored in the classification storage module, on the display module; and a second display control module that, in response to an operator's operation command of activating one of the multiple group switches, displays an image processing option switch for execution of an image processing option included in a group corresponding to the activated group switch, on the display module. The tone bit number detection module receives the operator's operation command of activating another group switch, which is different from a specific group switch corresponding to a specific group including the specific image processing option, as the execution instruction of the next image processing option and carries out the determination, based on another group corresponding to the activated another group switch.

In response to the operator's activation of another group switch, which is different from the specific group switch corresponding to the specific group including the specific image processing option, when it is determined, based on another group corresponding to the activated another group switch, that the next image processing option handles the image data of the greater tone bit number than the tone bit number of the specific image processing option, this embodiment of the second image processing apparatus prohibits execution of the next image processing option.

In the first image processing apparatus of this preferable embodiment using the group switches and image processing option switches, a descending order of the tone bit numbers of the plural groups in the classification storage module may be set to a display order of the plural group switches respectively corresponding to the plural groups.

This arrangement enables the operator to execute a series of operations in the display order of the plural group switches, thus ensuring the good workability.

It is preferable that the image processing prohibition module has a notification module that notifies the operator of prohibited execution of the next image processing.

The operator is thus informed of impracticability of the next image processing option. This arrangement ensures the good interface to the operator.

The present invention is also directed to a second image processing apparatus that sequentially executes at least two image processing options, which are selected among multiple image processing options provided in advance, with regard to input image data to retouch the input image data, wherein the multiple image processing options are designed to process image data of different tone bit numbers expressible in each pixel. The second image processing apparatus includes: a display module; a classification storage module that stores in advance a result of classification of the multiple image processing options into plural groups by the tone bit number; a first display control module that displays plural group switches respectively corresponding to the plural groups of classification stored in the classification storage module, on the display module in a descending order of the tone bit numbers of the plural groups corresponding to the plural group switches; and a second display control module that, in response to an operator's operation command of activating one of the multiple group switches, displays an image processing option switch for execution of an image processing option included in a group corresponding to the activated group switch, on the display module.

The second image processing apparatus of the invention facilitates the operator's sequentially executing the multiple image processing options with regard to the input image data in the display order of the plural group switches displayed by the first display control module. The operator collectively executes image processing options for the image data of the greater tone bit number, prior to execution of image processing options for the image data of the smaller tone bit number. The structure of the third image processing apparatus reduces the potential for execution of the image processing option grouped into the greater tone bit number with regard to the image data converted from the smaller tone bit number. The image processing for the greater tone bit number thus ensures the expected performances. This arrangement desirably prevents potential deterioration of the picture quality.

In the first or the second image processing apparatus discussed above, the different tone bit numbers expressible in each pixel may be 16 bits and 8 bits.

The present invention is also directed to a third image processing apparatus that sequentially executes at least two image processing options, which are selected among multiple image processing options provided in advance, with regard to input image data to retouch the input image data, wherein the multiple image processing options are designed to process image data of different tone bit numbers expressible in each pixel. The third image processing apparatus includes: a classification storage module that stores in advance a result of classification of the multiple image processing options into plural groups by the tone bit number; and an execution order control module that sets an execution order of the at least two image processing options to be equivalent to a descending order of the tone bit numbers of the image data processed by the at least two image processing options, based on the result of classification stored in the classification storage module.

The third image processing apparatus of the invention sets the descending order of the tone bit numbers of the processed image data to the execution order of the at least two image processing options and executes the at least tow image processing options in the preset execution order. The respective image processing options classified into the plural groups of the bit number tone thus ensure the expected performances. The structure of the fourth image processing apparatus restrains the image data converted to the smaller tone bit number for execution of a specific image processing option from going through any subsequent image processing option grouped into the greater tone bit number than the tone bit number of the specific image processing option. This arrangement enables the respective image processing options to exert the expected performances and thereby desirably prevents potential deterioration of the picture quality.

In one preferable embodiment of the invention, the third image processing apparatus further includes: an image processing specification module that sequentially specifies the at least two image processing options to be executed for the input image data, in response to an operator's operation instructions; a parameter acquisition module that, every time the image processing specification module specifies one image processing option, obtains a parameter representing a retouch degree of the specified image processing option in response to the operator's operation command; a retouch record update module that, every time the image processing specification module specifies one image processing option, adds the specified image processing option with the corresponding parameter obtained by the parameter acquisition module, to a retouch record file; and an image processing execution module that, every time the image processing specification module specifies one image processing option, generates output image data as a retouch result, based on the input image data, the retouch record file, and the execution order set by the execution order control module.

The operator sequentially specifies desired image processing options to be executed with regard to the input image data and rearranges the specified multiple image processing options in an optimum execution order in response to specification of each image processing option. This arrangement thus generates the high-quality output image data every time one image processing option is specified.

In this embodiment of the invention that generates the high-quality output image data in response to every specification of a desired image processing option, it is preferable that the third image processing apparatus further includes: a display device; an input device that receives entry of the operator's operation; and a display control module that displays a screen area for data input on the display device. The display control module has: an instruction switch display control module that provides multiple instruction switches in the screen area to receive the operator's operation instruction in the image processing specification module, where the multiple instruction switches correspond to the multiple image processing options; and an output image data display control module that displays the output image data generated by the image processing execution module, in the screen area.

The operator specifies desired image processing options to be executed with regard to the input image data in the screen area for data input on the display device, and checks the output image data as a result of the specified image processing options in the screen area.

In the third image processing apparatus, the different tone bit numbers expressible in each pixel may be 16 bits and 8 bits.

The present invention is also directed to a fourth image processing apparatus that sequentially executes at least two image processing options, which are selected among multiple image processing options provided in advance, with regard to input image data to retouch the input image data, wherein each of the multiple image processing options is designed to process image data of a preset tone bit number, which is expressible in each pixel and is equal to either of a first value and a second value that is smaller than the first value. The fourth image processing apparatus includes: a layer formation module that forms a layer to make a result of an image processing option reflected on the input image data; an image processing specification module that specifies a preset image processing option selected among the multiple image processing options with regard to the input image data, in response to an operator's operation instruction; a tone bit number detection module that determines whether the tone bit number of image data processed by the preset image processing option, which is specified by the image processing specification module, is equal to the first value or the second value; a first image processing execution module that executes the preset image processing option with regard to the input image data, when the tone bit number detection module determines that the tone bit number of the image data processed by the preset image processing option is equal to the first value; a second image processing execution module that executes the preset image processing option with regard to the layer, when the tone bit number detection module determines that the tone bit number of the image data processed by the preset image processing option is equal to the second value; and a composition module that lays the layer upon the input image data to generate composite image data.

The fourth image processing apparatus of the invention forms a layer and executes the image processing options for the preset tone bit number expressible in each pixel equal to the first value (that is greater than the second value) with regard to the input image data, while executing the image processing options for the preset tone bit number equal to the second value with regard to the layer. The composition module lays the layer upon the input image data to generate composite image data. The structure of the fifth image processing apparatus uses the input image data to collectively execute the image processing options for the greater tone bit number equal to the first value, and subsequently uses the layer to execute the image processing options for the smaller tone bit number equal to the second value. This structure restrains image data converted from the smaller tone bit number from going through any subsequent image processing option grouped into the greater tone bit number. The image processing for the greater tone bit number thus ensures the expected performances. This arrangement desirably prevents potential deterioration of the picture quality.

In one preferable embodiment of the fourth image processing apparatus, the layer formation module forms a first layer and a second layer to be laid upon the input image data in this order. The second image processing execution module has: a processing type determination module that determines whether the preset image processing option is a type of image processing option that involves attachment of a new image for additional design effect; a first layer execution module that executes the preset image processing option with regard to the first layer, when the tone bit number detection module determines that the tone bit number of the image data processed by the preset image processing option is equal to the second value and when the processing type determination module determines that the preset image processing option is not the type of image processing option that involves attachment of a new image for additional design effect; and a second layer execution module that executes the preset image processing option with regard to the second layer, when the tone bit number detection module determines that the tone bit number of the image data processed by the preset image processing option is equal to the second value and when the processing type determination module determines that the preset image processing option is the type of image processing option that involves attachment of a new image for additional design effect.

In this embodiment of the fourth image processing apparatus, the image processing options of handling the image data of the tone bit number equal to the second value are further divided by the execution object and are grouped into the second layer used for the image processing that involves attachment of a new image for the additional design effect and the first layer used for the image processing that does not involve attachment of a new image. The image processing option that involves attachment of a new image for the additional design effect masks at least part of the input image data located immediately below the attached new image. Subsequent image processing may accordingly not give the desired effects to the input image data. The structure of this embodiment executes the image processing that does not involve attachment of a new image on the lower first layer prior to execution of the image processing that involves attachment of a new image. This desirably prevents the effect of the image processing that does not involve attachment of a new image from being damaged by subsequent image processing that involves attachment of a new image.

The present invention is further directed to a fifth image processing apparatus that sequentially executes at least two image processing options, which are selected among multiple image processing options provided in advance, with regard to input image data to retouch the input image data, wherein each of the multiple image processing options is designed to process image data of a preset tone bit number, which is expressible in each pixel and is equal to either of a first value and a second value that is smaller than the first value. The fifth image processing apparatus includes: a layer formation module that forms multiple layers to make results of image processing options reflected on the input image data; an image processing specification module that specifies a preset image processing option selected among the multiple image processing options with regard to the input image data, in response to an operator's operation instruction; a tone bit number detection module that determines whether the tone bit number of image data processed by the preset image processing option, which is specified by the image processing specification module, is equal to the first value or the second value; a first image processing execution module that executes the preset image processing option with regard to a lower-most layer among the multiple layers, when the tone bit number detection module determines that the tone bit number of the image data processed by the preset image processing option is equal to the first value; a second image processing execution module that executes the preset image processing option with regard to a layer other than the lower-most layer among the multiple layers, when the tone bit number detection module determines that the tone bit number of the image data processed by the preset image processing option is equal to the second value; and a composition module that successively lays the multiple layers upon the input image data to generate composite image data.

The fifth image processing apparatus of the invention forms multiple layers and executes the image processing options for the preset tone bit number expressible in each pixel equal to the first value (that is greater than the second value) with regard to the lower-most layer among the multiple layers, while executing the image processing options for the preset tone bit number equal to the second value with regard to a layer other than the lower-most layer. The composition module successively lays multiple layers upon the input image data to generate composite image data. The structure of the sixth image processing apparatus uses the lower-most layer to collectively execute the image processing options for the greater tone bit number equal to the first value, and subsequently uses another layer to execute the image processing options for the smaller tone bit number equal to the second value. This structure restrains image data converted from the smaller tone bit number from going through any subsequent image processing option grouped into the greater tone bit number. The image processing for the greater tone bit number thus ensures the expected performances. This arrangement desirably prevents potential deterioration of the picture quality.

In one preferable embodiment of the fifth image processing apparatus, the layer formation module forms a first layer, a second layer, and a third layer to be laid upon the input image data in this order. The second image processing execution module has: a processing type determination module that determines whether the preset image processing option is a type of image processing option that involves attachment of a new image for additional design effect; a first layer execution module that executes the preset image processing option with regard to the second layer, when the tone bit number detection module determines that the tone bit number of the image data processed by the preset image processing option is equal to the second value and when the processing type determination module determines that the preset image processing option is not the type of image processing option that involves attachment of a new image for additional design effect; and a second layer execution module that executes the preset image processing option with regard to the third layer, when the tone bit number detection module determines that the tone bit number of the image data processed by the preset image processing option is equal to the second value and when the processing type determination module determines that the preset image processing option is the type of image processing option that involves attachment of a new image for additional design effect.

In this embodiment of the fifth image processing apparatus, the image processing options of handling the image data of the tone bit number equal to the second value are further divided by the execution object and are grouped into the third layer used for the image processing that involves attachment of a new image for the additional design effect and the second layer used for the image processing that does not involve attachment of a new image. The image processing option that involves attachment of a new image for the additional design effect masks at least part of the input image data located below the attached new image. Subsequent image processing may accordingly not give the desired effects to the input image data. The structure of this embodiment executes the image processing that does not involve attachment of a new image on the lower second layer prior to execution of the image processing that involves attachment of a new image. This desirably prevents the effect of the image processing that does not involve attachment of a new image from being damaged by subsequent image processing that involves attachment of a new image.

The present invention is further directed to a sixth image processing apparatus that sequentially executes at least two image processing options, which are selected among multiple image processing options provided in advance, with regard to input image data to retouch the input image data, wherein the multiple image processing options are designed to process image data of different tone bit numbers expressible in each pixel. The sixth image processing apparatus includes: a layer formation module that forms multiple layers to make results of image processing options reflected on the input image data; a classification storage module that stores in advance information representing classification of the multiple image processing options into plural groups by the tone bit number, where the information relates the input image data to a specified group of a greatest tone bit number among the plural groups, while respectively relating the multiple layers to residual groups other than the specified group among the plural groups such that an upper layer corresponds to a smaller tone bit number; an image processing specification module that specifies a preset image processing option selected among the multiple image processing options with regard to the input image data, in response to an operator's operation instruction; a layer detection module that refers to the information stored in the classification storage module and selects an execution object of the preset image processing specified by the image processing specification module among the input image data and the multiple layers; an image processing execution module that executes the preset image processing option specified by the image processing specification module with regard to the selected one of the input image data and the multiple layers by the layer detection module; and a composition module that successively lays the multiple layers upon the input image data to generate composite image data.

The sixth image processing apparatus of the invention forms multiple layers and executes the image processing options grouped into the greater tone bit number expressible in each pixel with regard to the input image data, while executing the image processing options in other groups with regard to the multiple layers in the descending order of the tone bit numbers. The composition module successively lays the multiple layers upon the input image data to generate composite image data. This arrangement ensures execution of the image processing options for the greater tone bit number, prior to execution of the image processing options for the smaller tone bit number. This structure restrains image data converted from the smaller tone bit number from going through any subsequent image processing option grouped into the greater tone bit number. The image processing for the greater tone bit number thus ensures the expected performances. This arrangement desirably prevents potential deterioration of the picture quality.

The present invention is also directed to an seventh image processing apparatus that sequentially executes at least two image processing options, which are selected among multiple image processing options provided in advance, with regard to input image data to retouch the input image data, wherein the multiple image processing options are designed to process image data of different tone bit numbers expressible in each pixel. The seventh image processing apparatus includes: a layer formation module that forms multiple layers to make results of image processing options reflected on the input image data; a classification storage module that stores in advance information representing classification of the multiple image processing options into plural groups by the tone bit number, where the information respectively relates the multiple layers to the plural groups such that an upper layer corresponds to a smaller tone bit number; an image processing specification module that specifies a preset image processing option selected among the multiple image processing options with regard to the input image data, in response to an operator's operation instruction; a layer detection module that refers to the information stored in the classification storage module and selects an execution object of the preset image processing specified by the image processing specification module among the multiple layers formed by the layer formation module; an image processing execution module that executes the preset image processing option specified by the image processing specification module with regard to the selected one of the multiple layers by the layer detection module; and a composition module that successively lays the multiple layers upon the input image data to generate composite image data.

The seventh image processing apparatus of the invention forms multiple layers and sequentially executes the image processing options according to the respective tone bit numbers expressible in each pixel with regard to the respective layers in the descending order of the tone bit numbers. The composition module successively lays the multiple layers upon the input image data to generate composite image data. This arrangement ensures execution of the image processing options for the greater tone bit number, prior to execution of the image processing options for the smaller tone bit number. This structure restrains image data converted from the smaller tone bit number from going through any subsequent image processing option grouped into the greater tone bit number. The image processing for the greater tone bit number thus ensures the expected performances. This arrangement desirably prevents potential deterioration of the picture quality.

The present invention is also directed to an eighth image processing apparatus that sequentially executes at least two image processing options, which are selected among multiple image processing options provided in advance, with regard to input image data to retouch the input image data, wherein the multiple image processing options are designed to process image data of different tone bit numbers expressible in each pixel. The eighth image processing apparatus includes: a classification storage module that stores in advance a result of classification of the multiple image processing options into plural groups by the tone bit number; and a processing module that executes the at least two image processing options in a preset order with regard to the input image data, based on the tone bit numbers of the respective image processing options and the result of classification stored in the classification storage module.

The eighth image processing apparatus of the invention executes the at least two image processing options in the preset order with regard to the input image data, based on the tone bit numbers of the respective image processing options and the result of classification that classifies the multiple image processing options into plural groups by the tone bit number. The operator specifies the execution order of the multiple image processing options according to their tone bit numbers. This arrangement desirably prevents potential deterioration of the picture quality due to the execution order of the at least two image processing options.

The present invention is further directed to a first image processing method that sequentially executes at least two image processing options, which are selected among multiple image processing options provided in advance, with regard to input image data to retouch the input image data, wherein the multiple image processing options are designed to process image data of different tone bit numbers expressible in each pixel. The first image processing method includes the steps of: (a) storing a result of classification of the multiple image processing options into plural groups by the tone bit number; (b) in response to an execution instruction of a next image processing option after execution of a specific image processing option with regard to the input image data, referring to the result of classification stored in the step (a) and determining whether the next image processing option is supposed to process image data of a greater tone bit number than a tone bit number of image data processed by the specific image processing option; and (c) prohibiting execution of the next image processing option when it is determined in the step (b) that the next image processing option is supposed to process the image data of the greater tone bit number.

The present invention is also directed to a corresponding first computer program product that is used to sequentially execute at least two image processing options, which are selected among multiple image processing options provided in advance, with regard to input image data and thereby retouch the input image data. The computer program includes: (a) a first program for causing a computer to store a result of classification of the multiple image processing options into plural groups by the tone bit number; (b) a second program for, in response to an execution instruction of a next image processing option after execution of a specific image processing option with regard to the input image data, causing the computer to refer to the result of classification stored by the first program and thereby determine whether the next image processing option is supposed to process image data of a greater tone bit number than a tone bit number of image data processed by the specific image processing option; and (c) a third program for causing the computer to prohibit execution of the next image processing option when it is determined by the second program that the next image processing option is supposed to process the image data of the greater tone bit number.

Like the first image processing apparatus discussed above, the corresponding first image processing method and the corresponding first computer program product of the invention effectively restrains the image data converted from the smaller tone bit number from going through any subsequent image processing option grouped into the greater tone bit number, thus desirably preventing potential deterioration of the picture quality.

The present invention is further directed to a second image processing method that sequentially executes at least two image processing options, which are selected among multiple image processing options provided in advance, with regard to input image data to retouch the input image data, wherein the multiple image processing options are designed to process image data of different tone bit numbers expressible in each pixel. The second image processing method includes the steps of: (a) storing a result of classification of the multiple image processing options into plural groups by the tone bit number; (b) displaying plural group switches respectively corresponding to the plural groups of classification stored in the step (a), on a display unit in a descending order of the tone bit numbers of the plural groups corresponding to the plural group switches; and (c) in response to an operator's operation command of activating one of the multiple group switches, displaying an image processing option switch for execution of an image processing option included in a group corresponding to the activated group switch, on the display unit.

The invention is also directed to a corresponding second computer program product that is used to sequentially execute at least two image processing options, which are selected among multiple image processing options provided in advance, with regard to input image data and thereby retouch the input image data. The second computer program product includes: a computer readable medium; and a computer program that is stored in the computer readable medium, wherein the multiple image processing options are designed to process image data of different tone bit numbers expressible in each pixel. The computer program includes: (a) a first program for causing a computer to store a result of classification of the multiple image processing options into plural groups by the tone bit number; (b) a second program for causing the computer to display plural group switches respectively corresponding to the plural groups of classification stored by first program, on a display unit in a descending order of the tone bit numbers of the plural groups corresponding to the plural group switches; and (c) a third program for, in response to an operator's operation command of activating one of the multiple group switches, causing the computer to display an image processing option switch for execution of an image processing option included in a group corresponding to the activated group switch, on the display unit.

Like the second image processing apparatus discussed above, the corresponding second image processing method and the corresponding second computer program product of the invention effectively restrains the image data converted from the smaller tone bit number from going through any subsequent image processing option grouped into the greater tone bit number, thus desirably preventing potential deterioration of the picture quality.

The present invention is further directed to a third image processing method that sequentially executes at least two image processing options, which are selected among multiple image processing options provided in advance, with regard to input image data to retouch the input image data, wherein the multiple image processing options are designed to process image data of different tone bit numbers expressible in each pixel. The third image processing method includes the steps of: (a) storing a result of classification of the multiple image processing options into plural groups by the tone bit number; and (b) setting an execution order of the at least two image processing options to be equivalent to a descending order of the tone bit numbers of the image data processed by the at least two image processing options, based on the result of classification stored in the step (a).

The invention is also directed to a corresponding third computer program product that is used to sequentially execute at least two image processing options, which are selected among multiple image processing options provided in advance, with regard to input image data and thereby retouch the input image data. The third computer program product includes: a computer readable medium; and a computer program that is stored in the computer readable medium, wherein the multiple image processing options are designed to process image data of different tone bit numbers expressible in each pixel. The computer program includes: (a) a first program for causing a computer to store a result of classification of the multiple image processing options into plural groups by the tone bit number; and (b) a second program for causing the computer to set an execution order of the at least two image processing options to be equivalent to a descending order of the tone bit numbers of the image data processed by the at least two image processing options, based on the result of classification stored by the first program.

Like the third image processing apparatus discussed above, the corresponding third image processing method and the corresponding third computer program product of the invention effectively restrains the image data converted from the smaller tone bit number from going through any subsequent image processing option grouped into the greater tone bit number, thus desirably preventing potential deterioration of the picture quality.

The present invention is further directed to a forth image processing method that sequentially executes at least two image processing options, which are selected among multiple image processing options provided in advance, with regard to input image data to retouch the input image data, wherein each of the multiple image processing options is designed to process image data of a preset tone bit number, which is expressible in each pixel and is equal to either of a first value and a second value that is smaller than the first value. The forth image processing method includes the steps of: (a) forming a layer to make a result of an image processing option reflected on the input image data; (b) specifying a preset image processing option selected among the multiple image processing options with regard to the input image data, in response to an operator's operation instruction; (c) determining whether the tone bit number of image data processed by the preset image processing option, which is specified in the step (b), is equal to the first value or the second value; (d) executing the preset image processing option with regard to the input image data, when it is determined in the step (c) that the tone bit number of the image data processed by the preset image processing option is equal to the first value; (e) executing the preset image processing option with regard to the layer, when it is determined in the step (c) that the tone bit number of the image data processed by the preset image processing option is equal to the second value; and (f) laying the layer upon the input image data to generate composite image data.

The invention is also directed to a corresponding forth computer program product that is used to sequentially execute at least two image processing options, which are selected among multiple image processing options provided in advance, with regard to input image data and thereby retouch the input image data. The forth computer program product includes: a computer readable medium; and a computer program that is stored in the computer readable medium, wherein each of the multiple image processing options is designed to process image data of a preset tone bit number, which is expressible in each pixel and is equal to either of a first value and a second value that is smaller than the first value. The computer program includes: (a) a first program for causing a computer to form a layer to make a result of an image processing option reflected on the input image data; (b) a second program for causing the computer to specify a preset image processing option selected among the multiple image processing options with regard to the input image data, in response to an operator's operation instruction; (c) a third program for causing the computer to determine whether the tone bit number of image data processed by the preset image processing option, which is specified by the second program, is equal to the first value or the second value; (d) a fourth program for causing the computer to execute the preset image processing option with regard to the input image data, when it is determined by the third program that the tone bit number of the image data processed by the preset image processing option is equal to the first value; (e) a fifth program for causing the computer to execute the preset image processing option with regard to the layer, when it is determined by the third program that the tone bit number of the image data processed by the preset image processing option is equal to the second value; and (f) a sixth program for causing the computer to execute lay the layer upon the input image data to generate composite image data.

Like the forth image processing apparatus discussed above, the corresponding fourth image processing method and the corresponding fourth computer program product of the invention effectively restrains the image data converted from the second tone bit number from going through any subsequent image processing option grouped into the first tone bit number (that is greater than the second tone bit number), thus desirably preventing potential deterioration of the picture quality.

The present invention is further directed to a fifth image processing method that sequentially executes at least two image processing options, which are selected among multiple image processing options provided in advance, with regard to input image data to retouch the input image data, wherein each of the multiple image processing options is designed to process image data of a preset tone bit number, which is expressible in each pixel and is equal to either of a first value and a second value that is smaller than the first value. The fifth image processing method includes the steps of: (a) forming multiple layers to make results of image processing options reflected on the input image data; (b) specifying a preset image processing option selected among the multiple image processing options with regard to the input image data, in response to an operator's operation instruction; (c) determining whether the tone bit number of image data processed by the preset image processing option, which is specified in the step (b), is equal to the first value or the second value; (d) executing the preset image processing option with regard to a lower-most layer among the multiple layers, when it is determined in the step (c) that the tone bit number of the image data processed by the preset image processing option is equal to the first value; (e) executing the preset image processing option with regard to a layer other than the lower-most layer among the multiple layers, when it is determined in the step (c) that the tone bit number of the image data processed by the preset image processing option is equal to the second value; and (f) successively laying the multiple layers upon the input image data to generate composite image data.

The invention is also directed to a corresponding fifth computer program product that is used to sequentially execute at least two image processing options, which are selected among multiple image processing options provided in advance, with regard to input image data and thereby retouch the input image data. The fifth computer program product includes: a computer readable medium; and a computer program that is stored in the computer readable medium, wherein each of the multiple image processing options is designed to process image data of a preset tone bit number, which is expressible in each pixel and is equal to either of a first value and a second value that is smaller than the first value. The computer program includes: (a) a first program for causing a computer to form multiple layers to make results of image processing options reflected on the input image data; (b) a second program for causing the computer to specify a preset image processing option selected among the multiple image processing options with regard to the input image data, in response to an operator's operation instruction; (c) a third program for causing the computer to determine whether the tone bit number of image data processed by the preset image processing option, which is specified by the second program, is equal to the first value or the second value; (d) a fourth program for causing the computer to execute the preset image processing option with regard to a lower-most layer among the multiple layers, when it is determined by the third program that the tone bit number of the image data processed by the preset image processing option is equal to the first value; (e) a fifth program for causing the computer to execute the preset image processing option with regard to a layer other than the lower-most layer among the multiple layers, when it is determined by the third program that the tone bit number of the image data processed by the preset image processing option is equal to the second value; and (f) a sixth program for causing the computer to successively lay the multiple layers upon the input image data to generate composite image data.

Like the fifth image processing apparatus discussed above, the corresponding fifth image processing method and the corresponding fifth computer program product of the invention effectively restrains the image data converted from the second tone bit number from going through any subsequent image processing option grouped into the first tone bit number (that is greater than the second tone bit number), thus desirably preventing potential deterioration of the picture quality.

The present invention is further directed to a sixth image processing method that sequentially executes at least two image processing options, which are selected among multiple image processing options provided in advance, with regard to input image data to retouch the input image data, wherein the multiple image processing options are designed to process image data of different tone bit numbers expressible in each pixel. The sixth image processing method includes the steps of: (a) forming multiple layers to make results of image processing options reflected on the input image data; (b) storing information representing classification of the multiple image processing options into plural groups by the tone bit number, where the information relates the input image data to a specified group of a greatest tone bit number among the plural groups, while respectively relating the multiple layers to residual groups other than the specified group among the plural groups such that an upper layer corresponds to a smaller tone bit number; (c) specifying a preset image processing option selected among the multiple image processing options with regard to the input image data, in response to an operator's operation instruction; (d) referring to the information stored in the step (b) and selecting an execution object of the preset image processing specified in the step (c) among the input image data and the multiple layers; (e) executing the preset image processing option specified in the step (c) with regard to the selected one of the input image data and the multiple layers in the step (d); and (f) successively laying the multiple layers upon the input image data to generate composite image data.

The invention is also directed to a corresponding sixth computer program product that is used to sequentially execute at least two image processing options, which are selected among multiple image processing options provided in advance, with regard to input image data and thereby retouch the input image data. The sixth computer program product includes: a computer readable medium; and a computer program that is stored in the computer readable medium, wherein the multiple image processing options are designed to process image data of different tone bit numbers expressible in each pixel. The computer program includes: (a) a first program for causing a computer to form multiple layers to make results of image processing options reflected on the input image data; (b) a second program for causing the computer to store information representing classification of the multiple image processing options into plural groups by the tone bit number, where the information relates the input image data to a specified group of a greatest tone bit number among the plural groups, while respectively relating the multiple layers to residual groups other than the specified group among the plural groups such that an upper layer corresponds to a smaller tone bit number; (c) a third program for causing the computer to specify a preset image processing option selected among the multiple image processing options with regard to the input image data, in response to an operator's operation instruction; (d) a fourth program for causing the computer to refer to the information stored by the second program and selecting an execution object of the preset image processing specified by the a third program among the input image data and the multiple layers; (e) a fifth program for causing the computer to execute the preset image processing option specified by the a third program with regard to the selected one of the input image data and the multiple layers by the function (d); and (f) a sixth program for causing the computer to successively lay the multiple layers upon the input image data to generate composite image data.

Like the sixth image processing apparatus discussed above, the corresponding sixth image processing method and the corresponding sixth computer program product of the invention effectively restrains the image data converted from the smaller tone bit number from going through any subsequent image processing option grouped into the greater tone bit number, thus desirably preventing potential deterioration of the picture quality.

The present invention is further directed to an seventh image processing method that sequentially executes at least two image processing options, which are selected among multiple image processing options provided in advance, with regard to input image data to retouch the input image data, wherein the multiple image processing options are designed to process image data of different tone bit numbers expressible in each pixel. The seventh image processing method includes the steps of: (a) forming multiple layers to make results of image processing options reflected on the input image data; (b) storing information representing classification of the multiple image processing options into plural groups by the tone bit number, where the information respectively relates the multiple layers to the plural groups such that an upper layer corresponds to a smaller tone bit number; (c) specifying a preset image processing option selected among the multiple image processing options with regard to the input image data, in response to an operator's operation instruction; (d) referring to the information stored in the step (b) and selecting an execution object of the preset image processing specified in the step (c) among the multiple layers formed in the step (a); (e) executing the preset image processing option specified in the step (c) with regard to the selected one of the multiple layers in the step (d); and (f) successively laying the multiple layers upon the input image data to generate composite image data.

The invention is also directed to a corresponding seventh computer program product that is used to sequentially execute at least two image processing options, which are selected among multiple image processing options provided in advance, with regard to input image data and thereby retouch the input image data. The seventh computer program product includes: a computer readable medium; and a computer program that is stored in the computer readable medium, wherein the multiple image processing options are designed to process image data of different tone bit numbers expressible in each pixel. The computer program includes: (a) a first program for causing a computer to form multiple layers to make results of image processing options reflected on the input image data; (b) a second program for causing the computer to store information representing classification of the multiple image processing options into plural groups by the tone bit number, where the information respectively relates the multiple layers to the plural groups such that an upper layer corresponds to a smaller tone bit number; (c) a third program for causing the computer to specify a preset image processing option selected among the multiple image processing options with regard to the input image data, in response to an operator's operation instruction; (d) a fourth program for causing the computer to refer to the information stored by the second program and selecting an execution object of the preset image processing specified by the a third program among the multiple layers formed by the first program; (e) a fifth program for causing the computer to execute the preset image processing option specified by the a third program with regard to the selected one of the multiple layers by the fourth program; and (f) a sixth program for causing the computer to successively lay the multiple layers upon the input image data to generate composite image data.

Like the seventh image processing apparatus discussed above, the corresponding seventh image processing method and the corresponding seventh computer program product of the invention effectively restrains the image data converted from the smaller tone bit number from going through any subsequent image processing option grouped into the greater tone bit number, thus desirably preventing potential deterioration of the picture quality.

The present invention is further directed to an eighth image processing method that sequentially executes at least two image processing options, which are selected among multiple image processing options provided in advance, with regard to input image data to retouch the input image data, wherein the multiple image processing options are designed to process image data of different tone bit numbers expressible in each pixel. The eighth image processing method includes the steps of: (a) storing a result of classification of the multiple image processing options into plural groups by the tone bit number; and (b) executing the at least two image processing options in a preset order with regard to the input image data, based on the tone bit numbers of the respective image processing options and the result of classification stored in the step (a).

The invention is also directed to a corresponding eighth computer program product that is used to sequentially execute at least two image processing options, which are selected among multiple image processing options provided in advance, with regard to input image data and thereby retouch the input image data. The eighth computer program product includes: a computer readable medium; and a computer program that is stored in the computer readable medium, wherein the multiple image processing options are designed to process image data of different tone bit numbers expressible in each pixel. The computer program includes: (a) a first program for causing a computer to store a result of classification of the multiple image processing options into plural groups by the tone bit number; and (b) a second program for causing the computer to executing the at least two image processing options in a preset order with regard to the input image data, based on the tone bit numbers of the respective image processing options and the result of classification stored by first program.

Like the eighth image processing apparatus discussed above, the corresponding eighth image processing method and the corresponding eighth computer program product of the invention effectively restrains the image data converted from the smaller tone bit number from going through any subsequent image processing option grouped into the greater tone bit number, thus desirably preventing potential deterioration of the picture quality.

The principle of the invention may be actualized by diversity of other applications. One possible application is any of computer programs recorded respectively in the first through the eighth computer program products of the invention discussed above. Another possible application is a program supply device that supplies any of such computer programs via a communication path. In this application, the computer programs are stored in a server on a computer network and are downloaded to the computer via the communication path according to the requirements. Execution of the downloaded computer program attains any of the image processing apparatuses and the image processing methods discussed above.

These and other objects, features, aspects, and advantages of the present invention will become more apparent from the following detailed description of the preferred embodiments with the accompanied drawings.

### BRIEF DESCRIPTION OF THE DRAWINGS

FIG. 1 is a block diagram schematically illustrating the hardware configuration of a computer system in a first embodiment of the invention;

FIG. 2 is a block diagram showing a control flow according to photo retouching software executed by a computer body included in the computer system of FIG. 1;

FIG. 3 is a flowchart showing a control routine executed in the first embodiment;

FIG. 4 shows an initial state of an application window WD;

FIG. 5 shows a classification table TBL including available image processing options grouped into a retouching pre-process and a retouching post-process;

FIG. 6 shows the application window WD open in the retouching pre-process;

FIG. 7 shows the application window WD open in the retouching post-process;

FIG. 8 is a flowchart showing an interruption routine executed according to the photo retouching software in the first embodiment;

FIG. 9 shows a message box MBX as an example;

FIG. 10 is a block diagram showing a control flow according to the photo retouching software executed by the computer body in a second embodiment of the invention;

FIG. 11 is a flowchart showing a control routine executed in the second embodiment;

FIG. 12 shows an initial state of an application window WD10;

FIG. 13 is a flowchart showing the details of the retouching process executed at step S1300 in the flowchart of FIG. 11;

FIG. 14 is a flowchart showing the details of the retouching process executed at step S1300 in the flowchart of FIG. 11;

FIG. 15 shows the display of the application window WD10 for the retouching process;

FIG. 16 shows a retouch record file FL1 as an example;

FIG. 17 shows an execution order storage file FL2 as an example;

FIG. 18 shows a ‘Rotation/Reversal’ dialog box DBX1;

FIG. 19 shows a ‘Contrast’ dialog box DBX2;

FIG. 20 shows a classification table TBL10 including available image processing options grouped into 16-bit color support and 8-bit color support;

FIG. 21 shows a process of rearranging records including an additional record to sort the execution order of image processing;

FIG. 22 is a block diagram showing a control flow according to the photo retouching software executed by the computer body in a third embodiment of the invention;

FIG. 23 is a flowchart showing a control routine executed in the third embodiment;

FIG. 24 is a flowchart showing the details of the retouching process executed at step S2300 in the flowchart of FIG. 23;

FIG. 25 conceptually shows two layers formed with regard to input image data Dpi in the third embodiment;

FIG. 26 shows the display of an application window WD20 for the Retouching process;

FIG. 27 shows a classification table TBL21 used in the third embodiment;

FIG. 28 conceptually shows three layers formed with regard to input image data Dpi in a fourth embodiment of the invention; and

FIG. 29 shows a classification table TBL22 used in the fourth embodiment.

### DESCRIPTION OF THE PREFERRED EMBODIMENTS

Some modes of carrying out the invention are discussed below as preferred embodiments in the following sequence:
A. First Embodiment
   A-1. System Configuration
   A-2. Computer Processing
      A-2-1. General Flow
      A-2-2. Interruption Process
   A-3. Functions and Effects
   A-4. Modifications
B. Second Embodiment
   B-1. System Configuration
   B-2. Computer Processing
      B-2-1. General Flow
      B-2-2. Retouching Process
   B-3. Functions and Effects
   B-4. Modifications
C. Third Embodiment
   C-1. System Configuration
   C-2. Computer Processing
      C-2-1. General Flow
      C-2-2. Retouching Process
   C-3. Functions and Effects
D. Fourth Embodiment

### E. Modifications

### A. First Embodiment

A-1. System Configuration

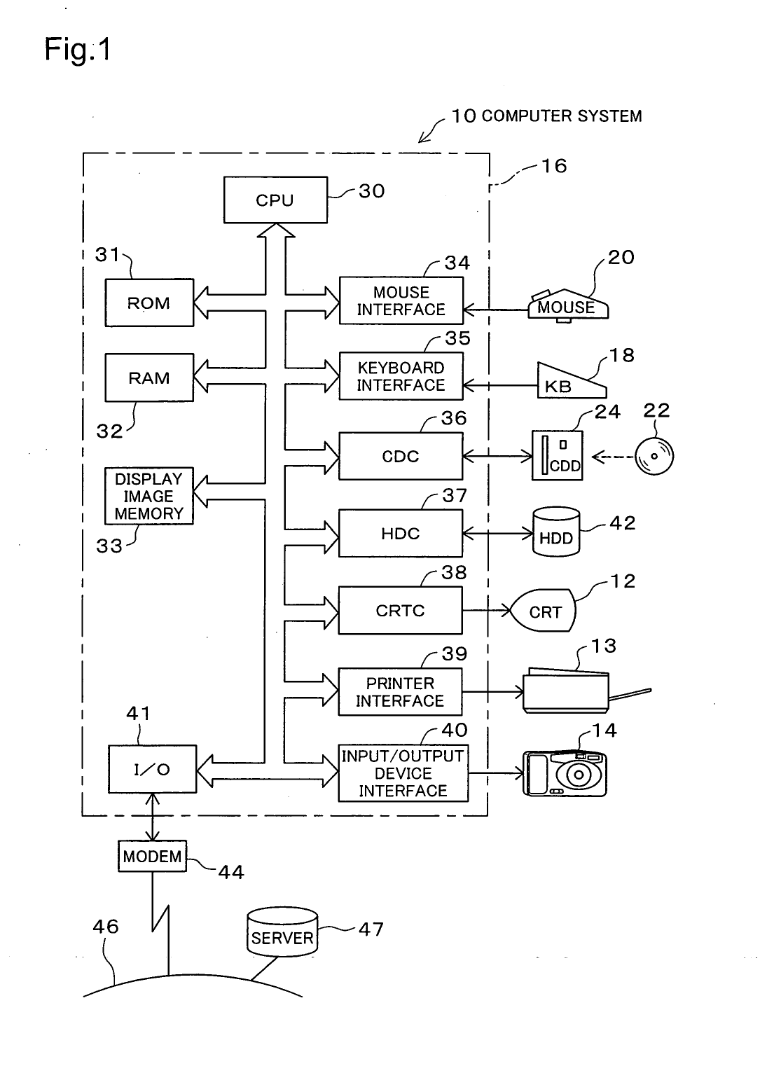

FIG. 1 is a block diagram schematically illustrating the hardware configuration of a computer system 10 in a first embodiment of the invention. This computer system 10 includes a personal computer (hereafter simply referred to as the computer), as well as a CRT display 12, a printer 13, and a digital camera 14 as peripheral devices. The computer has a computer body 16, a keyboard 18, and a mouse 20. A CD drive (CDD) 24 is mounted on the computer body 16 to read a CD-ROM 22.

The computer body 16 includes a CPU 30, a ROM 31, a RAM 32, a display image memory 33, a mouse interface 34, a keyboard interface 35, a CD controller (CDC) 36, an hard disk controller (HDC) 37, a CRT controller (CRTC) 38, a printer interface 39, an input/output device interface 40, and an I/O port 41, which are mutually connected via a bus. The ROM 31 stores various programs in a read-only manner, while the RAM 32 stores various data in a readable and writable manner. The display image memory 33 stores display image data representing images to be displayed on the CRT display 12.

The mouse interface 34 receives inputs from the mouse 20, and the keyboard interface 35 receives key inputs from the keyboard 18. The CDC 36 controls the CDD 24, and the HDC 37 controls a hard disk drive (HDD) 42, which has computer programs stored in advance.

The CRTC 38 controls display of images on the CRT display 12, based on the display image data stored in the display image memory 33. The printer interface 39 controls data input and output from and to the printer 13. The input/output device interface 40 controls data input and output from and to an externally connected input/output device, for example, the USB (Universal Serial Bus)-connected digital camera 14 in this embodiment. The I/O port 41 has a serial output port and is connected to a public telephone line 46 via a modem 44. The computer boy 16 is connected to an external network via the model 44 to be accessible to a particular server 47.

The digital camera 14 records image data that are expressed in 8-bit to 16-bit tones per pixel. Storage in a ‘RAW’ mode gives image data expressed in 16-bit tones (hereafter such expression is referred to as 16-bit color).

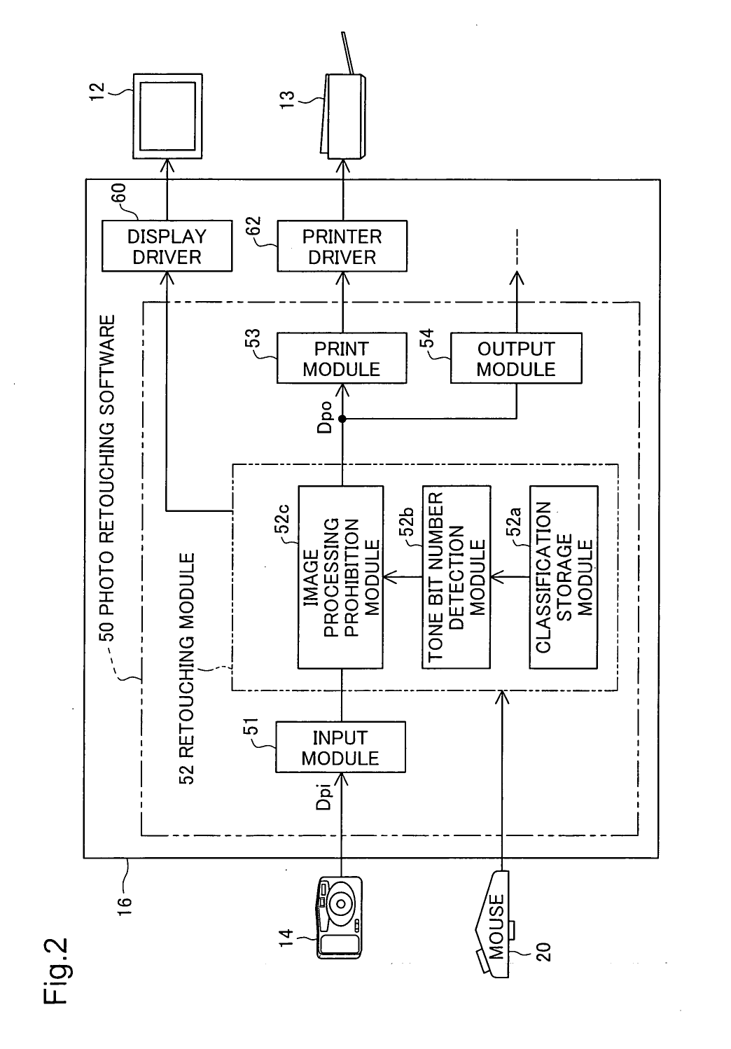

In this computer system 10, the operating system is stored in the HDD 42. In response to a power-on of the computer body 16, the operating system is loaded into a specific area in the RAM 32 according to a loader written in a boot block of the HDD 42. The CD-ROM 22 stores a photo retouching software program (computer program), which is used to retouch color photographic images taken with the digital camera 14. The computer program is installed as photo retouching software 50 (see FIG. 2) in the computer body 16 via the CD drive 24 by activation of a certain installation program. The installed photo retouching software 50 is stored in the HDD 42 and is loaded to a specific area in the RAM 32 in response to a preset start command.

The CPU 30 executes part of this photo retouching software program in the form of modules (described later) to actualize the functions of the invention. The photo retouching software program may be stored in a floppy disk, a magneto-optical disk, an IC card, or any other portable recording medium, instead of the CD-ROM 22. The photo retouching software program may alternatively be obtained by downloading program data from the particular server 47 connecting with the external network and transferring the downloaded program data to the RAM 32 or the HDD 42. The external network may be the Internet, and the photo retouching software program may be downloaded from a particular homepage. The photo retouching software program may otherwise be supplied as an attachment file to an e-mail.

A series of control executed according to the photo retouching software 50 in the computer system 10 of the above hardware configuration is described below. FIG. 2 is a block diagram showing a control flow according to the photo retouching software 50 executed by the computer body 16.

As shown in FIG. 2, in the photo retouching software 50 activated in the computer body 16, an input module 51 first reads image data Dpi representing a photographic image from the digital camera 14. The image data Dpi is 16-bit color image data stored in the ‘RAW’ mode in the digital camera 14. A retouching module 52 then retouches the input image data Dpi read by the input module 51 and outputs retouched image data Dpo. The retouching module 52 retouches the photographic image expressed by the input image data Dpi through a series of image processing, for example, rotation and trimming (cutout) of the image, adjustment of the brightness, the contrast, and the saturation of the image, compensation of the exposure of the image, and cross filter effects on the image. The required series of image processing is sequentially executed in response to the operator's instructions. The image under retouching by the retouching module 52 is sent to and displayed on the CRT display 12 via a display driver 60.

The retouching module 52 includes a classification storage module 52a, a tone bit number detection module 52b, and an image processing prohibition module 52c. The respective modules 52a, 52b, and 52c function to restrict the order of the image processing. This is characteristic of the invention and is described in detail later.

In the photo retouching software 50, a print module 53 transmits the retouched image data Dpo via a printer driver 62 to the printer 13 for printing, while an output module 54 transmits the retouched image data Dpo to an external device.

A-2. Computer Processing

A-2-1. General Flow

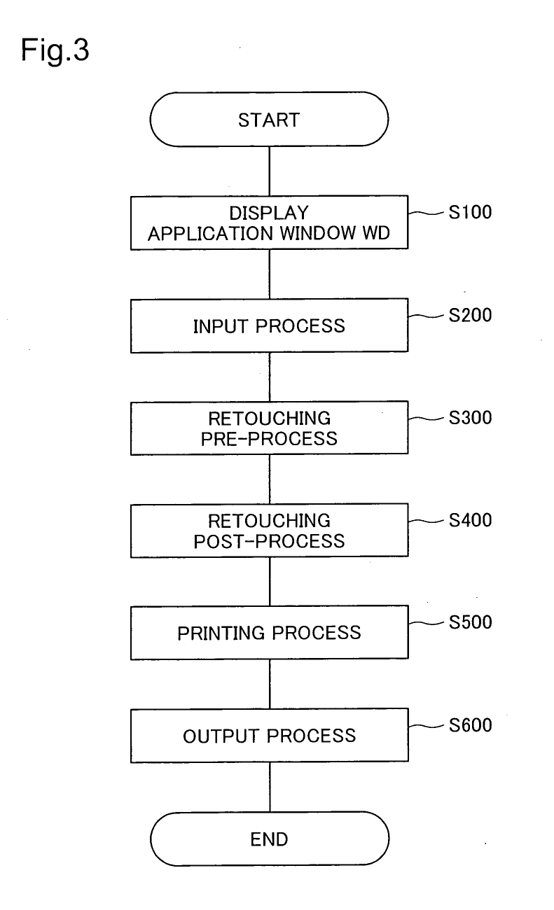

The CPU 30 of the computer body 16 executes the photo retouching software 50 to attain the functions of the input module 51, the retouching module 52, the print module 53, and the output module 54. The series of control according to the photo retouching software 50 is described in detail. FIG. 3 is a flowchart showing a control routine, which is executed in response to a start instruction of the photo retouching software 50.

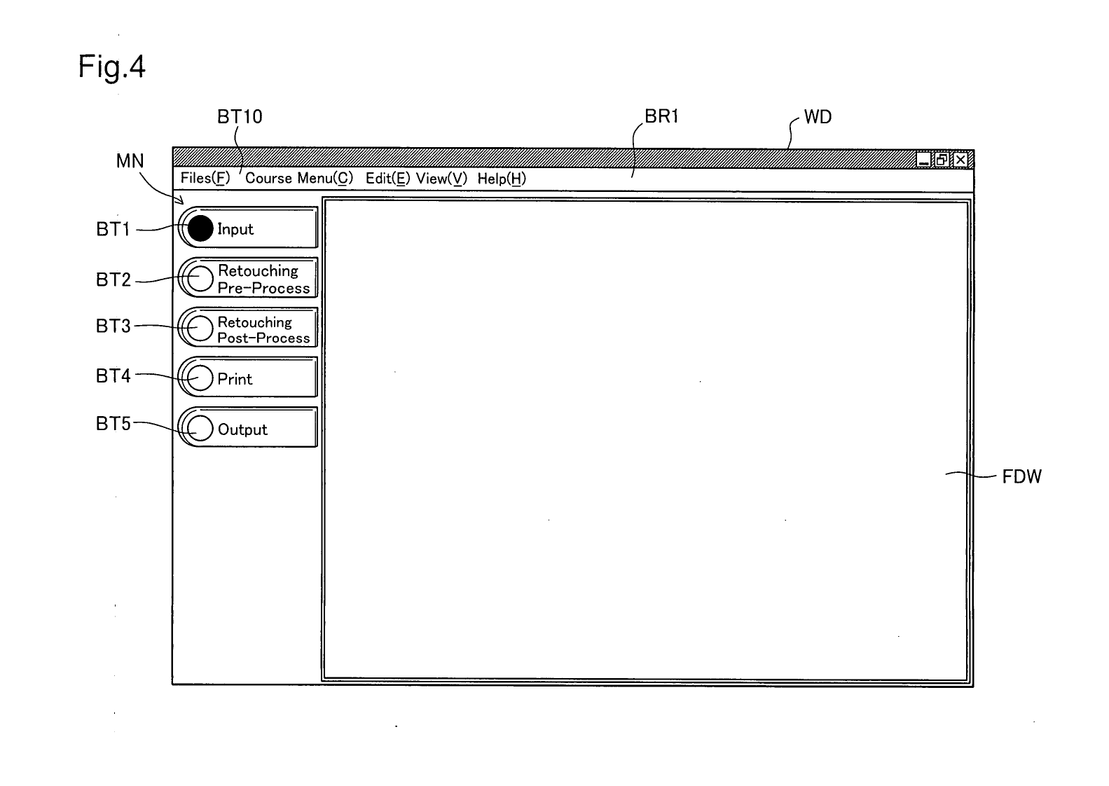

As illustrated, the CPU 30 first displays an application window WD on the CRT display 12 (step S100). FIG. 4 shows an initial state of the application window WD. The application window WD has five menu buttons BT1 to BT5 vertically downward aligned in a left processing menu window MN. The menu buttons BT1 to BT5 respectively represent ‘Input’, ‘Retouching Pre-Process’, ‘Retouching Post-Process’, ‘Print’, and ‘Output’. The operator sequentially clicks these menu buttons BT1 to BT5 with the mouse 20 to retouch a photographic image taken with the digital camera 14 and to output the retouched photographic image on the screen of the CRT display 12. The CPU 30 receives operation commands given by the operator's clicks of the menu buttons BT1 to BT5 with the mouse 20 after execution of step S100 and sequentially executes an input process, a retouching pre-process, a retouching post-process, a printing process, and an output process corresponding to the given operation commands (steps S200, S300, S400, S500, and S600) in the flowchart of FIG. 3.

The input process executed at step S200 corresponds to the input module 51 (see FIG. 2) and reads input image data Dpi representing a photographic image from the digital camera 14. The image data Dpi is input from the digital camera 14, when the operator clicks with the mouse 20 a ‘Files’ button BT10 in a menu bar BR1 on the application window WD shown in FIG. 4 to open a pulldown menu (not shown) and sequentially selects a menu option ‘External Device Input’, a desired input device, the digital camera 14 in this embodiment, and a desired file name. The input image data Dpi is the 16-bit color image data as mentioned above, and is stored in a specific area in the RAM 32 while being displayed in a work field FDW on the application window WD.

The retouching process executed at steps S300 and S400 retouches the input image data Dpi and is divided into the retouching pre-process and the retouching post-process. The retouching process retouches the input image data Dpi through a series of image processing. Some of the image processing is executed as the retouching pre-process, while the other of the image processing is executed as the retouching post-process.

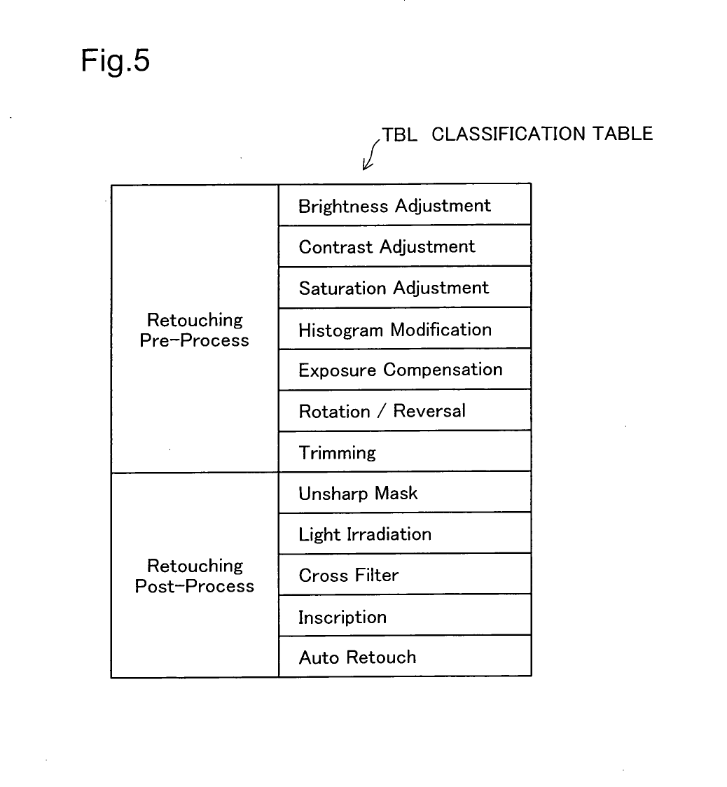

FIG. 5 shows a classification table TBL including available image processing options grouped into the retouching pre-process and the retouching post-process. The classification table TBL is stored in advance in the photo retouching software 50. The retouching pre-process includes image processing options ‘brightness adjustment’, ‘contrast adjustment’, ‘saturation adjustment’, ‘histogram modification’, ‘exposure compensation’, ‘rotation/reversal’, and ‘trimming’. The retouching post-process includes image processing options ‘unsharp mask’, ‘light irradiation’, ‘cross filter’, ‘inscription’, and ‘auto retouch’. The classification table TBL corresponds to the classification storage module 52a.

Part of the image processing is 16-bit color support that processes the image data as 16-bit color, while the other part of the image processing is 8-bit color support that processes the image data as 8-bit color. The 16-bit color support and the 8-bit color support are the software design specifications. The 16-bit color support is selectively used by taking into account the positive effects on the picture quality and the adverse effects on the processing speed and the operational performances of resources. The 16-bit color support is adopted for operations that demand the sufficient volume of information or operations that are required for foundation of the image, for example, compensation of the exposure and adjustment of the brightness and the contrast, while the 8-bit color support is adopted for operations that give intentional coloring effect or some design effect to the image.

In the structure of this embodiment, the series of image processing is divided into two groups with selection of the 16-bit color support or the 8-bit color support as the key of classification. The image processing of the 16-bit color support is grouped as the retouching pre-process, while the image processing of the 8-bit color support is grouped as the retouching post-process. The retouching pre-process includes the image processing options ‘brightness adjustment’, ‘contrast adjustment’, ‘saturation adjustment’, ‘histogram modification’, ‘exposure compensation’, ‘rotation/reversal’, and ‘trimming’, which are the operations required for foundation of the image. These image processing options are all 16-bit color support. The retouching post-process includes the image processing options ‘unsharp mask’, ‘light irradiation’, ‘cross filter’, ‘inscription’, and ‘auto retouch’, which are the operations to give intentional coloring effect or some design effect to the image. These image processing options are all 8-bit color support.

The image processing option ‘brightness adjustment’ varies the brightness of the image. The image processing option ‘contrast adjustment’ varies the contrast of the image. The image processing option ‘saturation adjustment’ varies the brightness of the image. The image processing option ‘histogram modification’ converts the color and the brightness of the image based on a histogram. The image processing option ‘exposure compensation’ gives the effect of exposure compensation to the image. The Image processing option ‘rotation/reversal’ rotates the image or reverses the image vertically or horizontally. The image processing option ‘trimming’ trims or cuts out a required part of the image.

The image processing option ‘unsharp mask’ gives the pseudo unsharp mask effect to the image. The image processing option ‘light irradiation’ gives the pseudo soft light irradiation effect to part of the image. The image processing option ‘cross filter’ gives the pseudo cross filter effect to the image. The image processing option ‘inscription’ inscribes letters and characters on the image. The image processing option ‘auto retouch’ automatically retouches the image to give optimal settings to the color and the brightness of the image.

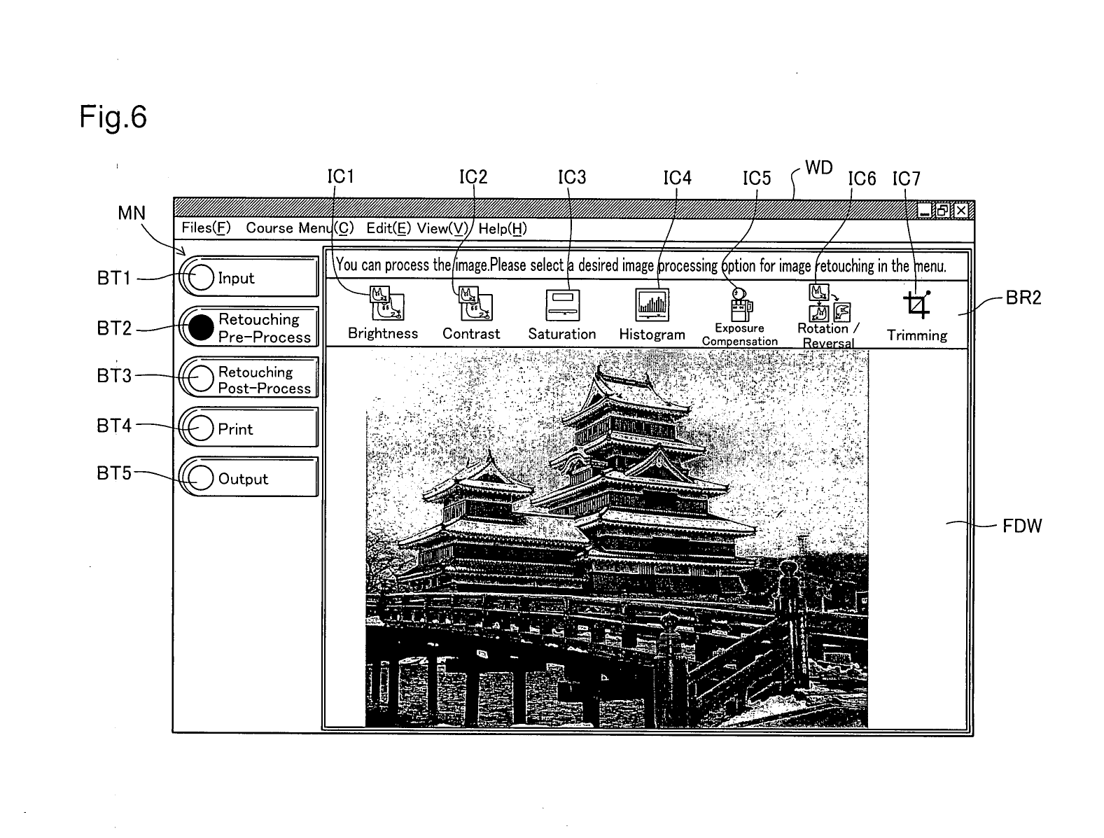

FIG. 6 shows the application window WD open in the retouching pre-process. As illustrated, in response to a click and selection of the menu button BT2 ‘Retouching Pre-Process’, icons IC1 ‘Brightness’, IC2 ‘Contrast’, IC3 ‘Saturation’, IC4 ‘Histogram’, IC5 ‘Exposure Compensation’, IC6 ‘Rotation/Reversal’, and IC7 ‘Trimming’ are shown in a tool bar BR2 on the application window WD. These icons IC1 to IC7 respectively correspond to the image processing options ‘brightness adjustment’, ‘contrast adjustment’, ‘saturation adjustment’, ‘histogram modification’, ‘exposure compensation’, ‘rotation/reversal’, and ‘trimming’. In the retouching pre-process executed at step S300, the operator manipulates the mouse 20 to selectively click one of the icons IC1 to IC7 and thereby give an execution command of the image processing option corresponding to the clicked one of the icons IC1 to IC7.

The CPU 30 of the computer body 16 receives the operator's execution command and makes the input image data Dpi, which has been read at step S200, subjected to the image processing corresponding to the clicked one of the icons IC1 to IC7. In the retouching pre-process executed at step S300, the operator may sequentially click multiple icons among the icons IC1 to IC7 to execute multiple corresponding image processing options. For example, the operator first clicks the icon IC7 ‘Trimming’ to trim a desired area of the input image data Dpi and subsequently clicks the icon IC2 ‘Contrast’ to vary the contrast of the image.

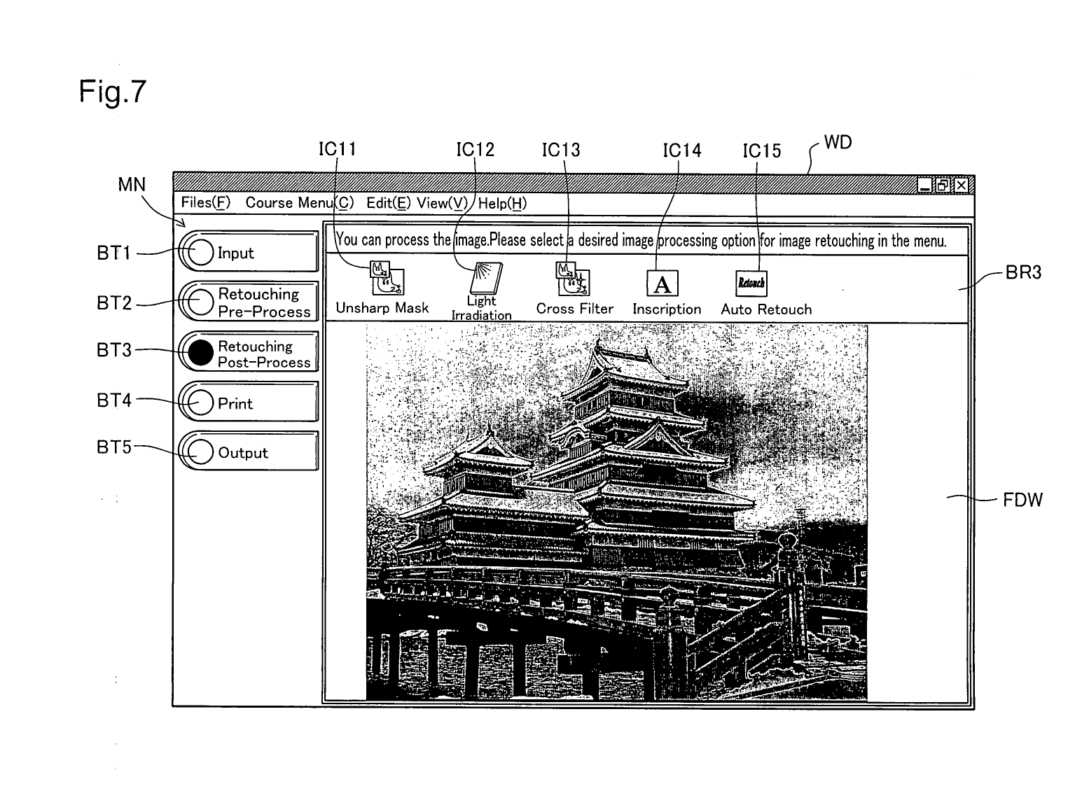

FIG. 7 shows the application window WD open in the retouching post-process. As illustrated, in response to a click and selection of the menu button BT3 ‘Retouching Post-Process’, icons IC11 ‘Unsharp Mask’, IC12 ‘Light Irradiation’, IC13 ‘Cross Filter’, IC14 ‘Inscription’, and IC15 ‘Auto Retouch’ are shown in a tool bar BR3 on the application window WD. These icons IC11 to IC15 respectively correspond to the image processing options ‘unsharp mask’, ‘light irradiation’, ‘cross filter’, ‘inscription’, and ‘auto retouch’. In the retouching post-process executed at step S400, the operator manipulates the mouse 20 to selectively click one of the icons IC11 to IC15 and thereby give an execution command of the image processing option corresponding to the clicked one of the icons IC11 to IC15.

The CPU 30 of the computer body 16 receives the operator's execution command and makes the input image data Dpi, which has been read at step S200 and has gone through the retouching pre-process, subjected to the image processing corresponding to the clicked one of the icons IC11 to IC15. The input image data Dpi is 16-bit color image data as mentioned previously. The image processing options included in the retouching pre-process executed at step S300 are all the 16-bit color support and thus do not require any additional data conversion prior to execution of the image processing. The image processing options included in the retouching post-process executed at step S400 are, however, all the 8-bit color support and accordingly require conversion of the 16-bit color image data into 8-bit color image data for color subtraction prior to execution of the image processing.

A simplest method of color subtraction from the 16-bit color to the 8-bit color drops the lower 8 bits of original image data and rightward shifts the upper 8 bits by 8 bit spaces. The resulting lower 8 bits is given as the solution. For example, the drop of the lower 8 bits and rightward shift of the upper 8 bits by 8 bit spaces converts original 16-bit image data ‘1011100011110000’ into ‘0000000010111000’. The solution is the lower 8 bits ‘10111000’. This color subtraction method is not restrictive at all and may be replaced by any of other diverse techniques.

In the retouching post-process executed at step S400, the operator may sequentially click multiple icons among the icons IC11 to IC15 to execute multiple corresponding image processing options. For example, the operator first clicks the icon IC11 ‘Unsharp Mask’ to give the pseudo unsharp mask effect to the input image data Dpi and subsequently clicks the icon IC14 ‘Inscription’ to add character data to the input image data Dpi. The conversion of the 16-bit color image data into the 8-bit color image data for color subtraction is carried out prior to execution of the first image processing option in the retouching post-process. No further color subtraction is naturally required after the conversion into the 8-bit color data.

Any of the image processing options executable at either step S300 or step S400 does not directly change the original input image data Dpi but adopts a ‘retouching parameter system’. The retouching parameter system stores image retouching information as settings of retouching parameters, independently of an original image. The operator checks the settings of the retouching parameters to identify the image processing options executed for the input image data Dpi.

The menu buttons BT2 ‘Retouching Pre-Process’ and BT3 ‘Retouching Pos-Process’ correspond to the ‘group switches’ of the invention. The icons IC1 to IC7 in the tool bar BR2 and the icons IC11 to IC15 in the tool bar BR3 correspond to the ‘image processing option switches’ of the invention.

Referring back to the flowchart of FIG. 3, the printing process executed at step S500 outputs the image data retouched at step S300 and at step S400 (retouched image data Dpo) as a print command to the printer driver. This printing process has the known configuration and is thus not specifically described here. The printer 13 accordingly prints the retouched photographic image.

The output process executed at step S600 outputs the retouched image data Dpo obtained after execution of steps S300 and S400 to an external device. The retouched image data Dpo representing the retouched photographic image is output to a desired external device.

As described above, the series of processing at steps S200 to S600 is sequentially executed in response to the operator's clicks of the five menu buttons BT1 ‘Input’, BT2 ‘Retouching Pre-Process’, BT3 ‘Retouching Post-Process’, BT4 ‘Print’, and BT5 ‘Output’ provided on the application window WD. The series of processing may be executed in a partly different order. For example, the printing process of step S500 and the output process of step S600 may be executed in the reverse order. The input process of step S200 should be executed first immediately after execution of step S100. The input image data Dpi read at step S200 may not go through the retouching pre-process of step S300 or the retouching post-process of step S400 but immediately goes to the printing process of step S500 or the output process of step S600.

The control flow may execute either of the retouching pre-process at step S300 and the retouching post-process at step S400, instead of both. In the case of execution of both the retouching pre-process and the retouching post-process, the operator is required to execute the retouching pre-process and the retouching post-process in this order. The control flow does not allow execution of the retouching pre-process subsequent to execution of the retouching post-process nor a return to the retouching pre-process subsequent to the sequential execution of the retouching pre-process and the retouching post-process. The structure of prohibiting execution of the retouching pre-process in any unauthorized order is characteristic of the invention and is described below in detail.

A-2-2. Interruption Process

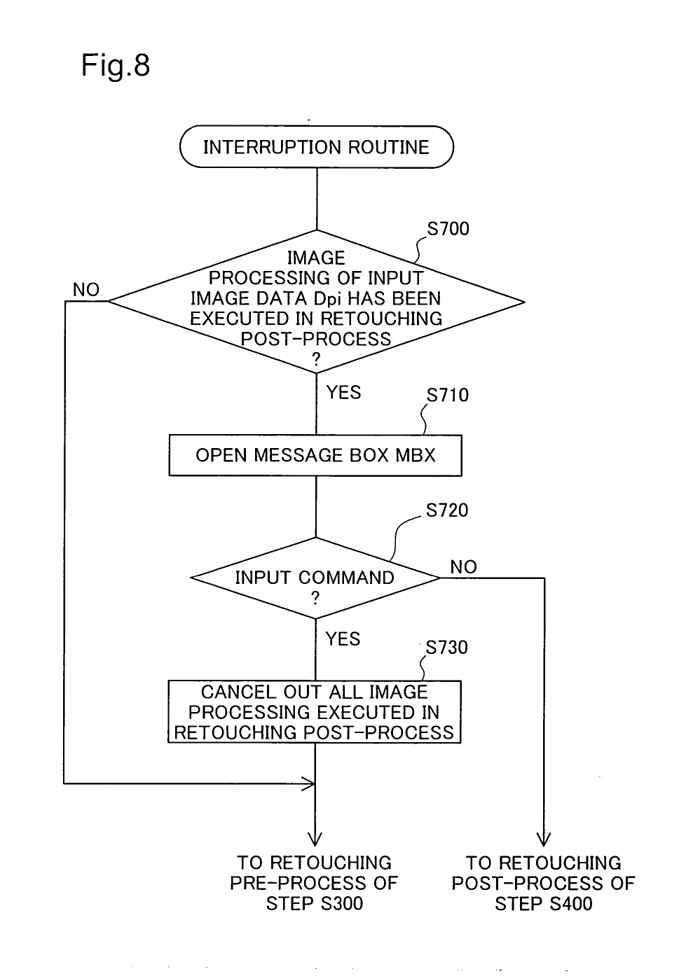

FIG. 8 is a flowchart showing an interruption routine executed according to the photo retouching software 50. The CPU 30 executes this interruption routine in an interruptive manner in response to the operator's click of the menu button BT3 ‘Retouching Pre-process’. The CPU 30 first determines whether image processing of the input image data Dpi read at step S200 (FIG. 3) has been executed in the retouching post-process of step S400 (step S700). As mentioned above, the details of the executed image processing are stored as the settings of the retouching parameters. The settings of the retouching parameters accordingly show the executed image processing options. Check of the executed image processing options in the classification table TBL of FIG. 5 determines whether the input image data Dpi has gone through the retouching post-process.

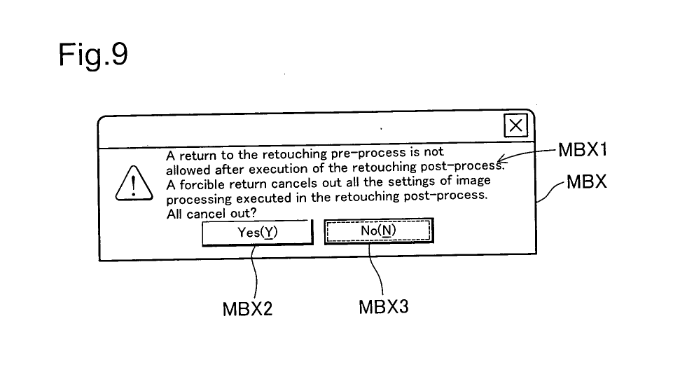

When it is determined at step S700 that the input image data Dpi has already gone through the image processing in the retouching post-process, the CPU 30 opens a message box MBX on the CRT display 12 (step S710). FIG. 9 shows an example of the message box MBX. The message box MBX includes a message MBX1 showing that a return to the retouching pre-process is not allowed after execution of the retouching post-process and that a forcible return to the retouching pre-process cancels out all the settings of image processing executed in the retouching post-process, a button MBX2 ‘Yes’, and a button MBX3 ‘No’.

Referring back to the flowchart of FIG. 8, after execution of step S710, the CPU 30 identifies an input command corresponding to the operator's click of either the button MBX2 ‘Yes’ or the button MBX3 ‘No’ in the message box MBX (step S720). In response to the identified input command corresponding to the click of the button MBX2 ‘Yes’, the CPU 30 cancels out all the settings of image processing executed in the retouching post-process of step S400 (step S730) and shifts to the retouching pre-process of step S300 in the flowchart of FIG. 3.

In response to the identified input command corresponding to the click of the button MBX3 ‘No’ at step S720, on the other hand, the CPU 30 shifts to the retouching post-process of step S400 in the flowchart of FIG. 3.

When it is determined at step S700 that the input image data Dpi has not yet gone through the image processing in the retouching post-process, the CPU 30 skips the processing of steps S710 to S730 and immediately shifts to the retouching pre-process of step S300.

The CPU 30 and the processing of step S700 executed by the CPU 30 correspond to the tone bit number detection module 52b shown in FIG. 2. The CPU 30 and the processing of steps S710 and S720 to the shift to step S400 executed by the CPU 30 correspond to the image processing prohibition module 52c.

A-3. Functions and Effects

As described above, in the computer system 10 of the first embodiment, when the operator clicks the menu button BT2 ‘Retouching Pre-Process’ after execution of the image processing grouped in the retouching post-process in response to the operator's click of the menu button BT3 ‘Retouching Post-Process’, the message box MBX is open to give a warning about a prohibited return to the retouching pre-process. A forcible return to the retouching pre-process cancels out all the settings of image processing executed in the retouching post-process. This prohibits execution of any image processing grouped in the retouching pre-process with regard to the image data retouched in the retouching post-process.

The operator is thus required to collectively execute the image processing options classified in the retouching pre-process. The image processing options grouped in the retouching pre-process all deal with the 16-bit color image data. The operator is only allowed to collectively execute desired image processing options for the 16-bit color image data in the retouching pre-process at step S300 and then execute desired image processing options for the 8-bit color image data in the retouching post-process at step S400. This procedure of the first embodiment prohibits image data converted from the 8-bit color to the 16-bit color from going through the subsequent 16-bit color support image processing. The 16-bit color support image processing thus ensures the expected performances. This arrangement desirably prevents potential deterioration of the picture quality.

In the structure of this embodiment, the menu button BT2 ‘Retouching Pre-Process’ and the menu button BT3 ‘Retouching Post-Process’ are aligned vertically downward in the processing menu window MN corresponding to the actual order of the operation procedure. Such layout ensures the operator's smooth and efficient operations in the displayed order and facilitates the operator's collective execution of the 16-bit color support image processing options prior to execution of the 8-bit color support image processing options. This arrangement reduces the potential for execution of the 16-bit color support image processing with regard to the image data converted from the 8-bit color to the 16-bit color and thus ensures the high picture quality.

The structure of this embodiment opens the message box MBX on the CRT display 12, while prohibiting a return of the image processing flow from the retouching post-process to the retouching pre-process. This arrangement informs the operator of the fact of prohibition and accordingly ensures the excellent interface performance. Notification to the operator may be given in the form of some sound, instead of the display of the message on the screen.

A-4. Modifications

The structure of the first embodiment discussed above may be modified in various ways. Some examples of possible modification are given below.

(1) In the first embodiment discussed above, the retouching pre-process includes the image processing options ‘brightness adjustment’, ‘contrast adjustment’, ‘saturation adjustment’, ‘histogram modification’, ‘exposure compensation’, ‘rotation/reversal’, and ‘trimming’. Other image processing options, for example, color balance adjustment, may be added to these options or may be replaced with some of these options. Some of the above image processing options may be omitted if not required. The retouching post-process includes the image processing options ‘unsharp mask’, ‘light irradiation’, ‘cross filter’, ‘inscription’, and ‘auto retouch’. Other image processing options, for example, mosaic or embossing, may be added to these options or may be replaced with some of these options. Some of the above image processing options may be omitted if not required.

(2) In the first embodiment discussed above, each of the image processing options is classified in one of the 16-bit color support and 8-bit color support. Specific image processing options may be grouped in both the 16-bit color support and the 8-bit color support. For example, the image processing options, trimming and rotation/reversal, do not deteriorate the image information in either the 16-bit color support or the 8-bit color support and may thus be grouped in both the 16-bit color support and the 8-bit color support. This modified procedure allows a return from the retouching post-process to the retouching pre-process when a subsequently executed image processing option is one of these specific image processing options. When the operator clicks the button BT2 ‘Retouching Pre-Process’ and selects the specific image processing option ‘rotation/reversal’ or ‘trimming’ on the tool bar BR3, the modified procedure permits execution of the selected image processing option.

(3) The procedure of the first embodiment opens the message box MBX to prohibit a return from the retouching post-process to the retouching pre-process. This may be replaced by any other suitable image processing prohibition means, for example, display of the button BT2 ‘Retouching Pre-Process’ in an unselectable manner.

(4) The procedure of the first embodiment may be modified by omitting the interruption routine of FIG. 8, which is triggered by the operator's click of the button BT2 ‘Retouching Pre-Process’. Like the structure of the first embodiment, in the structure of this modified example, the menu button BT2 ‘Retouching Pre-Process’ and the menu button BT3 ‘Retouching Post-Process’ are aligned vertically downward in the processing menu window MN corresponding to the actual order of the operation procedure. Such layout ensures the operator's smooth and efficient operations in the displayed order and facilitates the operator's collective execution of the 16-bit color support image processing options prior to execution of the 8-bit color support image processing options. This layout accordingly reduces the potential for execution of the 16-bit color support image processing with regard to the image data converted from the 8-bit color to the 16-bit color. The 16-bit color support image processing thus ensures the expected performances. This arrangement desirably prevents potential deterioration of the picture quality.

(5) In the structure of the first embodiment, the series of image processing is classified into the two groups, retouching pre-process and retouching post-process, which are respectively selectable by the click of the button BT2 ‘Retouching Pre-Process’ and by the click of the button BT3 ‘Retouching Post-Process’. One possible modification may delete the buttons BT2 ‘Retouching Pre-Process’ and BT3 ‘Retouching Post-Process’ to omit selection of the group but may allow the operator to directly select execution of a desired image processing option among the image processing options ‘brightness adjustment’, ‘contrast adjustment’, ‘saturation adjustment’, ‘histogram modification’, ‘exposure compensation’, ‘rotation/reversal’, ‘trimming’, ‘unsharp mask’, ‘light irradiation’, ‘cross filter’, ‘inscription’, and ‘auto retouch’. In response to the operator's execution command of a subsequent image processing option after execution of a certain image processing option, the modified procedure refers to the classification table TBL and determines whether the input image data is expected to go through the 16-bit color support image processing after execution of the 8-bit color support image processing. In the case of the affirmative answer, the procedure prohibits execution of the subsequent 16-bit color support image processing.

(6) In the first embodiment discussed above, the series of image processing is grouped into the 8-bit color support and the 16-bit color support. One possible modification may group the series of image processing into three or a greater number of bit color support groups, for example, 8-bit color support, 16-bit color support, and 24-bit color support. The procedure of this modified example prohibits execution of the subsequent 16-bit color support image processing after execution of the 8-bit color support image processing, execution of the subsequent 24-bit color support image processing after execution of the 8-bit color support image processing, and execution of the subsequent 24-bit color support image processing after execution of the 16-bit color support image processing.

(7) The input image data Dpi is taken with the digital camera in the structure of the first embodiment, but may otherwise be image data of an analog photograph or photogravure taken with a color scanner or any other suitable means. The input image data Dpi may be stored in advance in a storage device, such as the HDD 42, or may be externally taken via a network. The input image data Dpi may be black and white image data, instead of the color image data.

(8) The input image data Dpi is 16-bit color image data stored in the ‘RAW’ mode in the first embodiment, but may otherwise be 8-bit color image data. The 16-bit color support image processing may output finer values even when the input image has only 8-bit information. Execution of the subsequent 8-bit color support image processing eliminates the finer part of the output values. The technique of the invention is thus effectively applicable to the 8-bit color input image data to collectively execute the 16-bit color support image processing prior to execution of the 8-bit color support image processing and thereby take advantage of the finer part of the output values.

### B. Second Embodiment

A second embodiment of the invention is discussed below.

B-1. System Configuration

The computer system in the second embodiment of the invention has the same hardware configuration as that of the first embodiment shown in FIG. 1. The like numerals to those of the first embodiment denote the like elements.

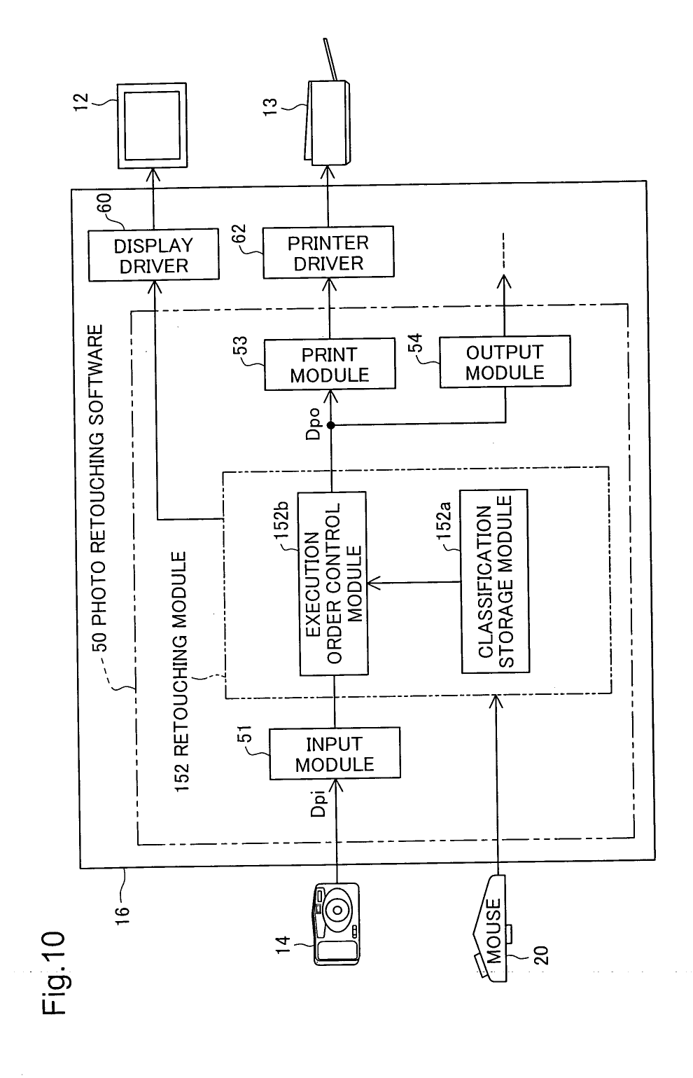

The software configuration of the second embodiment has some differences from that of the first embodiment. FIG. 10 is a block diagram showing a control flow according to the photo retouching software 50 executed by the computer body 16 in the second embodiment. The only difference from the software configuration of the first embodiment shown in FIG. 2 is the constituents of a retouching module 152.

The retouching module 152 of the second embodiment has a classification storage module 152a and an execution order control module 152b. The functions of these modules 152a and 152b determine the order of image processing. This is characteristic of the invention and is described in detail later.

B-2. Computer Processing

B-2-1. General Flow

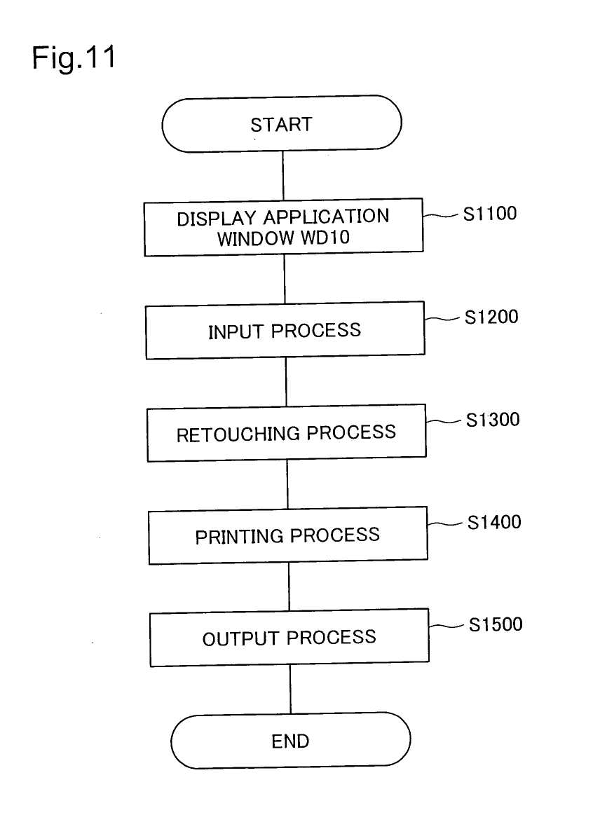

The CPU 30 of the computer body 16 executes the photo retouching software 50 to attain the functions of the input module 51, the retouching module 152, the print module 53, and the output module 54. The series of control according to the photo retouching software 50 is described in detail. FIG. 11 is a flowchart showing a control routine of the second embodiment, which is executed in response to a start instruction of the photo retouching software 50.

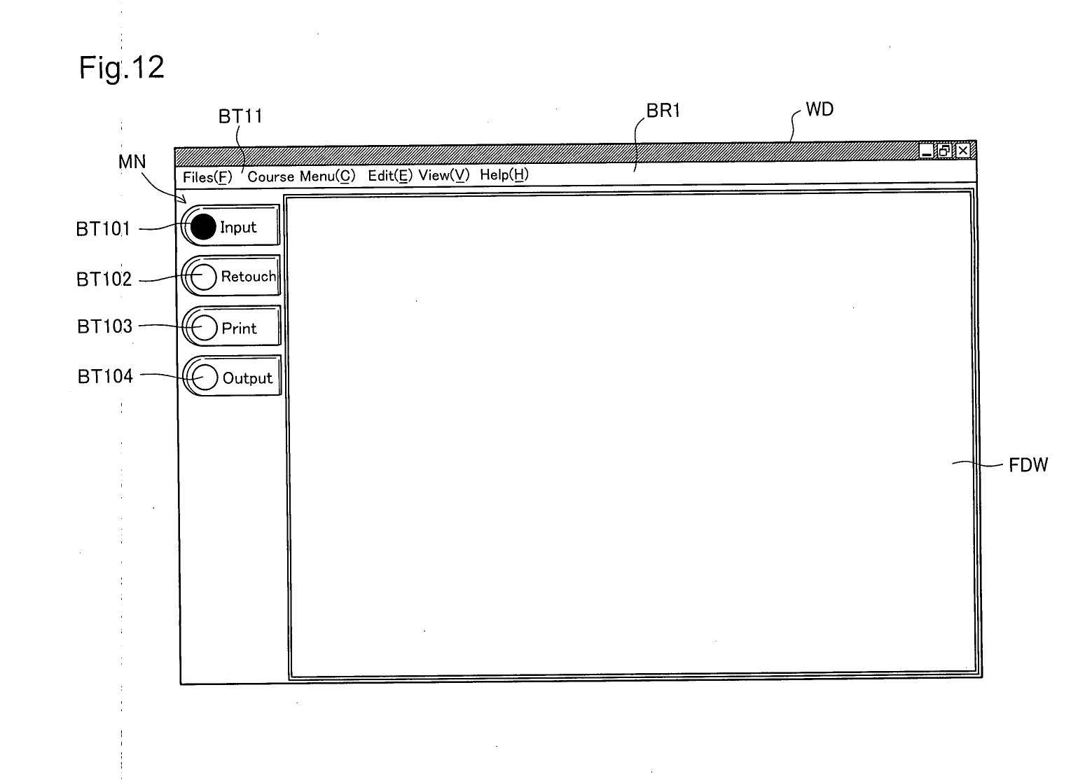

As illustrated, the CPU 30 first displays an application window WD10 on the CRT display 12 (step S1100). FIG. 12 shows an initial state of the application window WD10. The application window WD10 has four menu buttons BT101 to BT104 vertically downward aligned in a left processing menu window MN. The menu buttons BT101 to BT104 respectively represent ‘Input’, ‘Retouch’, ‘Print’, and ‘Output’. The operator sequentially clicks these menu buttons BT101 to BT104 with the mouse 20 to retouch a photographic image taken with the digital camera 14 and to output the retouched photographic image on the screen of the CRT display 12. The CPU 30 receives operation commands given by the operator's clicks of the menu buttons BT101 to BT104 with the mouse 20 after execution of step S1100 and sequentially executes an input process, a retouching process, a printing process, and an output process corresponding to the given operation commands (steps S1200, S1300, S1400, and S1500) in the flowchart of FIG. 11.

The input process executed at step S1200 is identical with the input process of step S200 executed in the first embodiment and corresponds to the input module 51 (see FIG. 10). The printing process executed at step S1400 is identical with the printing process of step S500 executed in the first embodiment and corresponds to the printing module 53 (FIG. 10). The output process executed at step S1500 is identical with the output process of step S600 executed in the first embodiment and corresponds to the output module 54 (FIG. 10).

The retouching process executed at step S1300, which is characteristic of the invention, retouches the input image data Dpi through a series of image processing. The retouched image data Dpo after the image processing is stored in a predetermined folder provided in the HDD 42. This retouching process corresponds to the retouching module 152 (FIG. 10).

B-2-2. Retouching Process

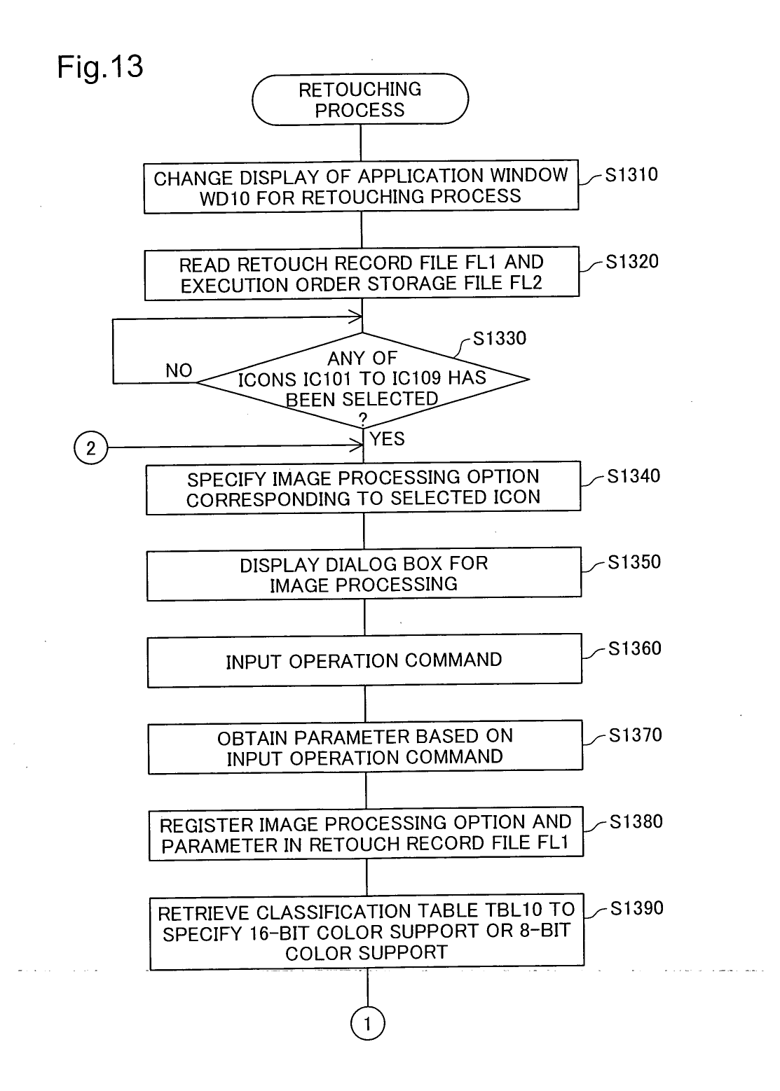

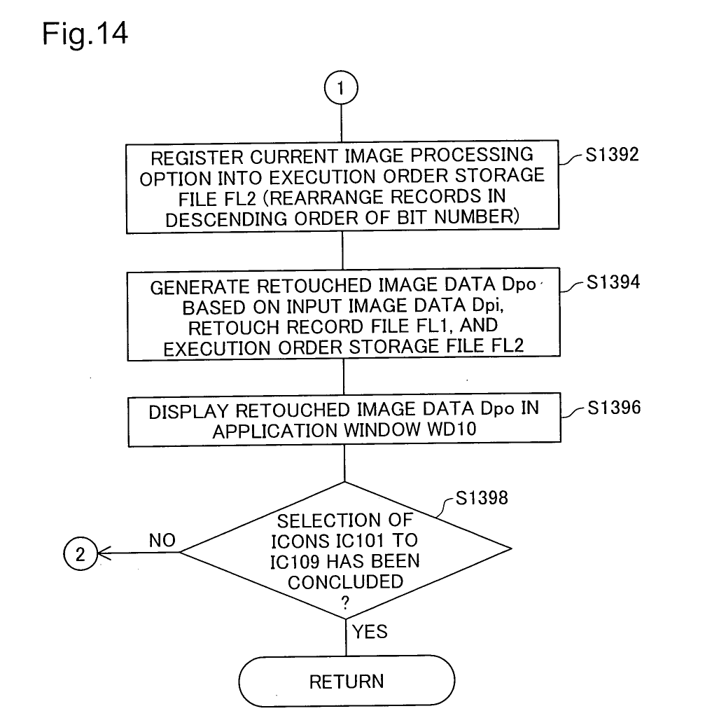

The retouching process executed at step S1300 in the flowchart of FIG. 11 is described in detail. FIGS. 13 and 14 are flowcharts showing the details of the retouching process. The CPU 30 first changes the display of the application window WD10 for the retouching process on the CRT display 12 (step S1310).

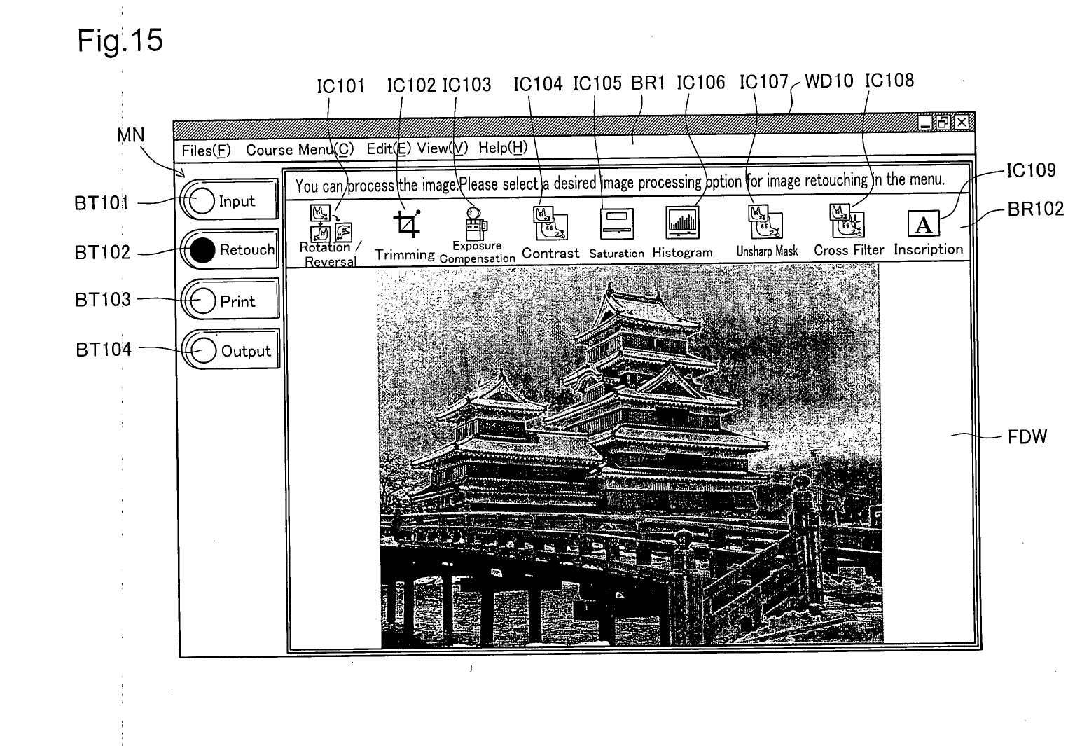

FIG. 15 shows the display of the application window WD10 for the retouching process. As illustrated, a tool bar BR102 in the application window WD10 for the retouching process includes icons IC101 ‘Rotation/Reversal’, IC102 ‘Trimming’, IC103 ‘Exposure Compensation’, IC104 ‘Contrast’, IC105 ‘Saturation’, IC106 ‘Histogram’, IC107 ‘Unsharp Mask’, IC108 ‘Cross Filter’, and IC109 ‘Inscription’. The operator manipulates the mouse 20 to selectively click one of the icons IC101 to IC109 and thereby give an execution command of the desired image processing option corresponding to the clicked one of the icons IC101 to IC109.

The icons IC101 to IC109 are instruction switches represented by picture symbols. The instruction switches are not restricted to the icons IC101 to IC109 but may be menu options open from the menu bar BR1.

The Image processing option ‘rotation/reversal’ rotates the image or reverses the image vertically or horizontally. The image processing option ‘trimming’ trims or cuts out a required part of the image. The image processing option ‘exposure compensation’ gives the effect of exposure compensation to the image. The image processing option ‘contrast adjustment’ varies the contrast of the image. The image processing option ‘saturation adjustment’ varies the brightness of the image. The image processing option ‘histogram modification’ converts the color and the brightness of the image based on a histogram. The image processing option ‘unsharp mask’ gives the pseudo unsharp mask effect to the image. The image processing option ‘cross filter’ gives the pseudo cross filter effect to the image. The image processing option ‘inscription’ inscribes letters and characters on the image.

Referring back to FIG. 13, after execution of step S1310, the CPU 30 reads a retouch record file FL1 and an execution order storage file FL2 from the RAM 32 (step S1320). The retouch record file FL1 stores a record of retouching executed for the input image data Dpi read at step S1200 in the flowchart of FIG. 11.

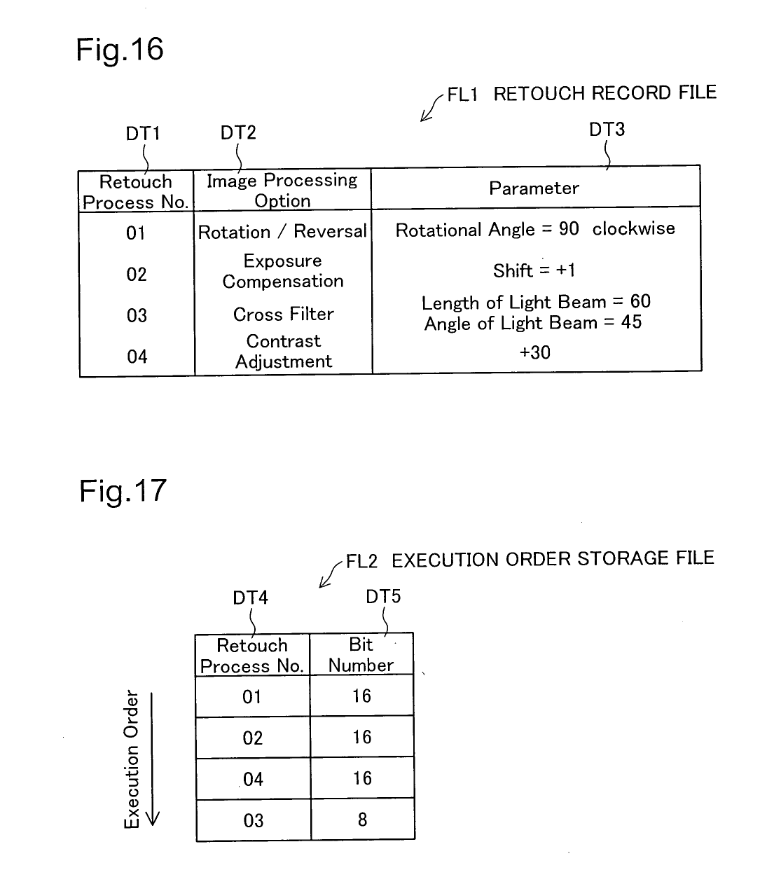

FIG. 16 shows one example of the retouch record file FL1. As illustrated, the retouch record file FL1 includes data DT1 ‘retouch process number’, DT2 ‘image processing option’, and DT3 ‘parameter’. The details of the respective data DT1 through DT3 will be described later. The retouch record file FL1 includes null data when the retouching process of step S1300 is executed for the first time after execution of the input process at step S1200.

The execution order storage file FL2 stores an execution order of the image processing options registered in the retouch record file FL1. FIG. 17 shows one example of the execution order storage file FL2. As illustrated, the execution order storage file FL2 includes data DT4 ‘retouch process number’ and DT5 ‘bit number’. The data DT4 ‘retouch process number’ is transferred from the data DT1 ‘retouch process number’ included in the retouch record file FL1. The data DT5 ‘bit number’ will be discussed later. The execution order storage file FL2 shows the execution order in the vertically downward direction. The execution order storage file FL2 includes null data when the retouching process of step S1300 is executed for the first time after execution of the input process at step S1200.

Referring back to the flowchart of FIG. 13, after execution of step S1320, the CPU 30 inputs the operator's instruction corresponding to a click of the mouse 20 and determines whether the operator has selected any one of the icons IC101 to IC109 in the application window WD10 (step S1330). In the case of no selection of any of the icons IC101 to IC109, the CPU 30 repeatedly executes the processing of step S1330 and waits for selection of any one of the icons IC101 to IC109.

When it is determined at step S1330 that one of the icons IC101 to IC109 has been selected, the CPU 30 specifies the image processing option corresponding to the selected one of the icons IC101 to IC109 (step S1340). For example, when the operator clicks the icon IC101 ‘Rotation/Reversal’, the CPU 30 specifies ‘rotation/reversal’ as the selected image processing option. When the operator clicks the icon IC104 ‘Contrast’, the CPU 30 specifies ‘contrast adjustment’ as the selected image processing option.

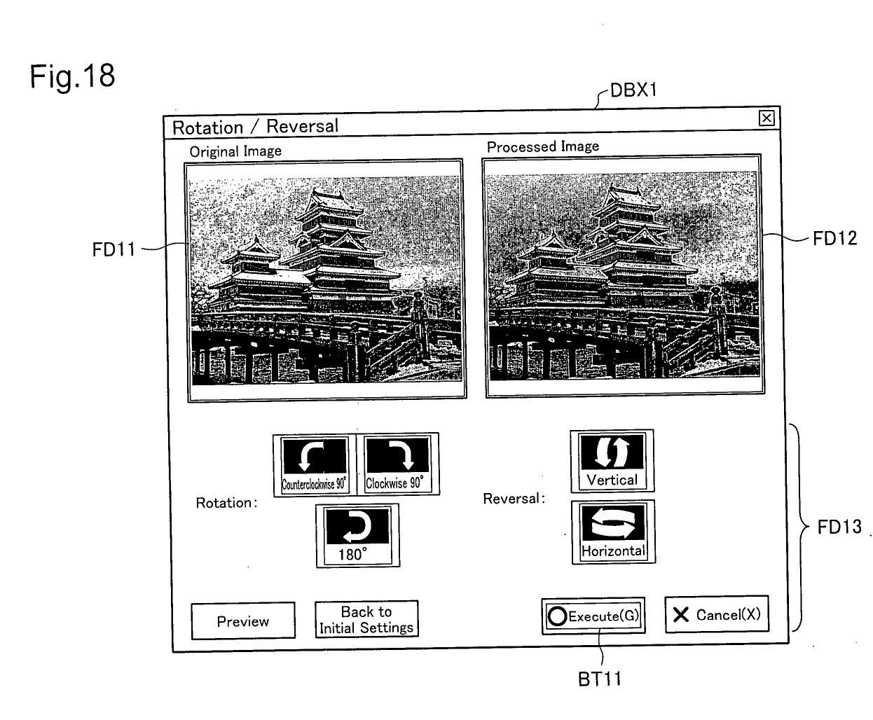

The CPU 30 subsequently displays a dialog box for the image processing option specified at step S1340 (step S1350). FIG. 18 shows a ‘Rotation/Reversal’ dialog box DBX1 displayed in response to the operator's click of the icon IC101 ‘Rotation/Reversal’. As illustrated, the dialog box DBX1 includes an original image display field FD11, a processed image display field FD12, and an operation field FD13.

The operation field FD13 includes buttons ‘Counterclockwise 90°’ ‘Clockwise 90°’, ‘180°’ for rotation and buttons ‘Vertical’ and ‘Horizontal’ for reversal. The operator clicks these buttons to rotate or reverse the image data. The result of rotation or reversal is shown in the processed image display field FD12. In response to a click of a button BT11 ‘Execute’ in the operation field FD13, the rotation or reversal specified by the operation instruction corresponding to the click of the selected button is stored as the ‘rotation/reversal’ parameter in the RAM 32.

The ‘rotation/reversal’ parameter is obtained at step S1360 and S1370 in the retouching routine of FIG. 13. The CPU 30 inputs the operator's operation command entered in the displayed dialog box for the specified image processing option (step S1360) and obtains a parameter representing the retouching specification, based on the input operation command (step S1370).

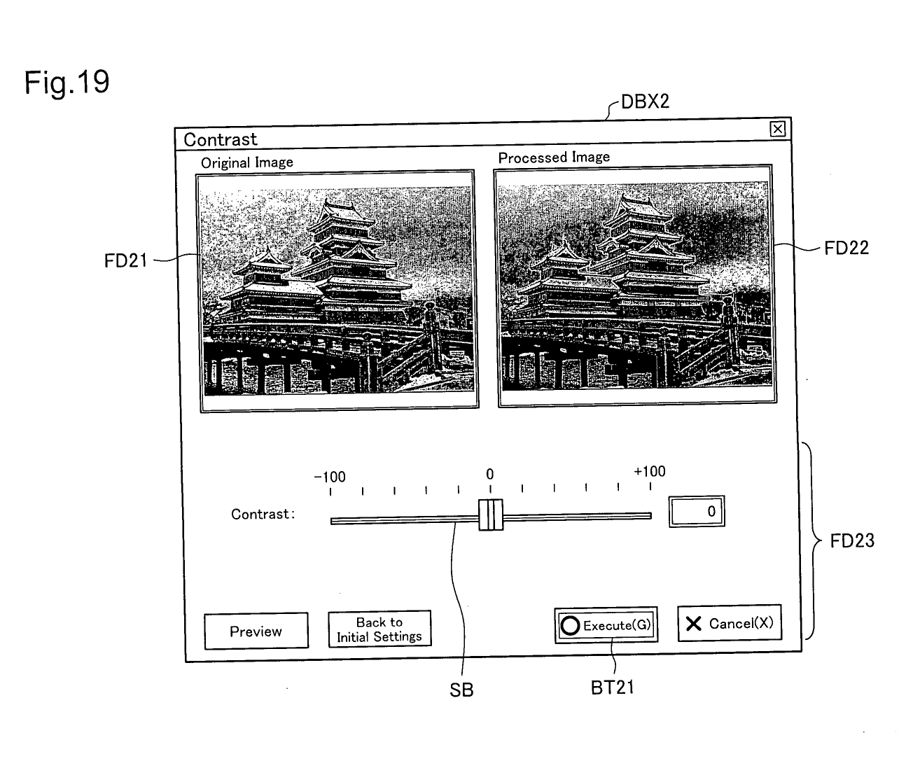

FIG. 19 shows a ‘Contrast’ dialog box DBX2 displayed in response to the operator's click of the icon IC104 ‘Contrast’. As illustrated, the dialog box DBX2 includes an original image display field FD21, a processed image display field FD22, and an operation field FD23.

The operation field FD23 includes a ‘Contrast’ slider bar SB, which is used to adjust a luminance range of the whole image. The operator manipulates this slider bar SB to adjust the contrast of the image data. The result of contrast adjustment is shown in the processed image display field FD22. In response to a click of a button BT21 ‘Execute’ in the operation field FD23, the selected value on the slider bar SB is stored as the ‘contrast’ parameter in the RAM 32 according to the processing of steps S1360 and S1370.

The above description regards the ‘rotation/reversal’ parameter and the ‘contrast’ parameter obtained by the processing of steps S1350 to S1370 in the flowchart of FIG. 13. In general, the procedure obtains a parameter with regard to the specified image processing option. For example, the procedure obtains a parameter of coordinate information representing an object area of image processing in response to the specified image processing option ‘trimming’. The procedure obtains a parameter representing the intensity of the pseudo cross filter effect in response to the specified image processing option ‘cross filter’.

Referring back to the flowchart of FIG. 13, after execution of step S1370, the CPU 30 registers the image processing option specified at step S1340 and the parameter obtained at step S1370 into the retouch record file FL1 (step S1380). A concrete procedure adds a new record to the retouch record file FL1 shown in FIG. 16 and allocates a next number to the existing registered number to the data DT1 ‘retouch process number’ in the additional record. This number represents a registration number of the image processing option currently specified by a click of one of the icons IC101 to IC109. The procedure writes the image processing option specified at step S1340 in the data DT2 ‘image processing option’, and writes the parameter obtained at step S1370 in the data DT3 ‘parameter’.

The CPU 30 subsequently determines whether the image processing option specified at step S1340 corresponds to 16-bit color support or 8-bit color support (step S1390). The nine image processing options available in the retouching process are actualized by individual image processing modules in the computer program. There are 16-bit color support modules that process input image data as 16-bit color and 8-bit color support modules that process input image data as 8-bit color. The 16-bit color support and the 8-bit color support are the software design specifications of image processing. The 16-bit color support is selectively used by taking into account the positive effects on the picture quality and the adverse effects on the processing speed and the operational performances of resources. The 16-bit color support is adopted for operations that demand the sufficient volume of information or operations that are required for foundation of the image, for example, compensation of the exposure and adjustment of the contrast and the saturation, while the 8-bit color support is adopted for operations that give intentional coloring effect or some design effect to the image.

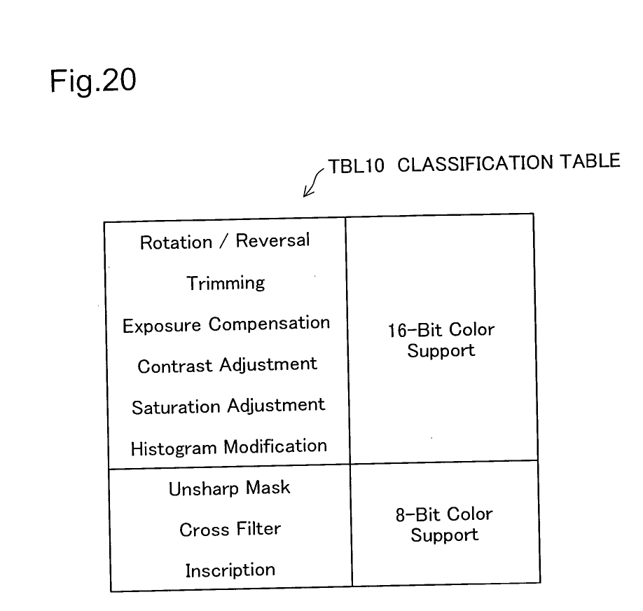

FIG. 20 shows a classification table TBL10 including the nine available image processing options grouped into the 16-bit color support and the 8-bit color support. The classification table TBL10 is stored in advance in the photo retouching software 50. In this embodiment, the image processing options ‘rotation/reversal’, ‘trimming’, ‘exposure compensation’, ‘contrast adjustment’, ‘saturation adjustment’, and ‘histogram modification’ are grouped in the 16-bit color support, while the other image processing options ‘unsharp mask’, ‘cross filter’, and ‘inscription’ are grouped in the 8-bit color support. The classification table TBL10 corresponds to the classification storage table 152a (see FIG. 10).

At step S1390, the CPU 30 retrieves the classification table TBL10 and determines whether the image processing option specified at step S1340 is the 16-bit color support or the 8-bit color support. The result of retrieval is stored as a bit number BT of the tone expressing each pixel into the RAM 32. The bit number BT is equal to 16 corresponding to the retrieval result of the 16-bit color support, while being equal to 8 corresponding to the retrieval result of the 8-bit color support.

After execution of step S1390, the CPU 30 proceeds to step S1392 in the flowchart of FIG. 14. At step S1392, the CPU 30 registers the image processing option currently specified in response to a click of the corresponding icon among the icons IC101 to IC109 into the execution order storage file FL2. The concrete procedure of registration adds a new record including the registration number of the current image processing option (the value of the data DT1 ‘retouch process number’) registered at step S1380 and the bit number BT specified at step S1390 to the execution order storage file FL2. The records including the newly added record (hereafter referred to as the additional record) are rearranged at the time of addition of the additional record.

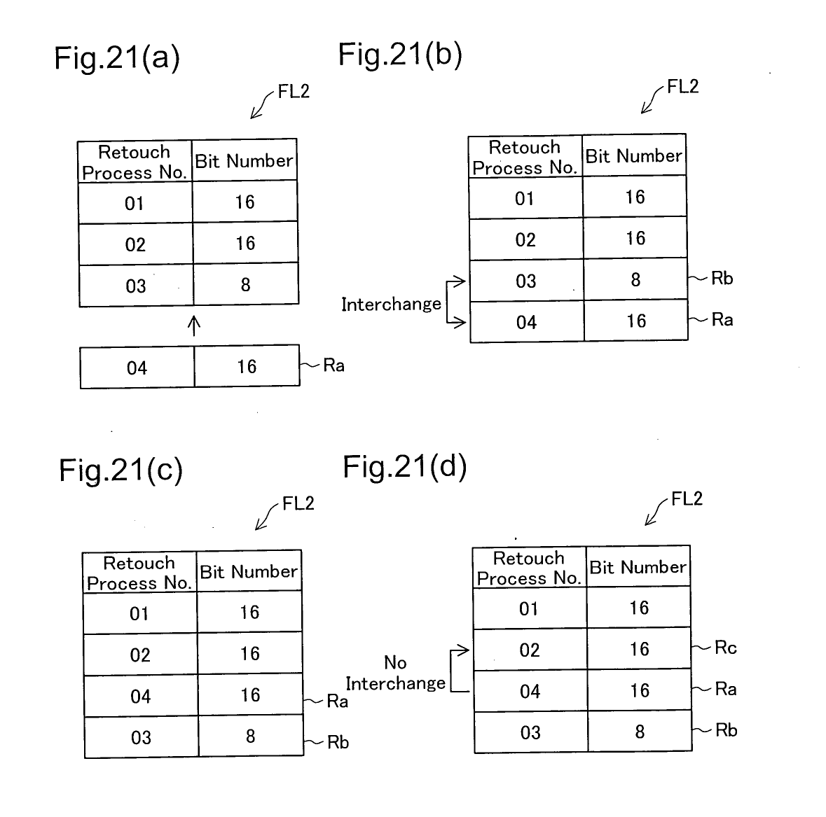

FIG. 21 shows a process of rearranging records including an additional record to sort the execution order of image processing. In this embodiment, the bubble sort technique is applied to this rearrangement process. The bubble sort technique compares magnitudes of adjoining elements and rearranges all the elements through required interchange of adjoining elements. The process first attaches an additional record Ra to the end of the execution order storage file FL2 as shown in FIG. 21(a) and compares the value of the data DT5 ‘bit number’ (hereafter simply referred to as ‘the bit number’) in the additional record Ra with that in a last record Rb immediately before the additional record Ra (comparative record) as shown in FIG. 21(b). When the bit number of the additional record Ra is greater than the bit number of the comparative record Rb, the positions of the additional record Ra and the comparative record Rb are interchanged. The additional record Ra and the comparative record Rb are thus rearranged in the descending order of the bit number as shown in FIG. 21(c).

The process then sets a last record Rc immediately before the rearranged additional record Ra to the new comparative record and compares the bit number of the additional record Ra with the bit number of the new comparative record Rc as shown in FIG. 21(d). When the bit number of the additional record Ra is not greater than the bit number of the new comparative record Rc, that is, when the bit number of the additional record Ra is equal to or smaller than the bit number of the new comparative record Rc, the positions of the additional record Ra and the comparative record Rc are not interchanged. In the case of no requirement of further interchange, the rearrangement process is concluded since all the upper records above the new comparative record Rc have already been arranged in the descending order of the bit number. The additional record Ra is accordingly located in the execution order storage file FL2 to ensure the arrangement in the descending order of the bit number.

For example, when the image processing options are specified in the order of ‘rotation/reversal’, ‘exposure compensation’, ‘cross filter’, and ‘contrast adjustment’ as shown in FIG. 16, the execution order storage file FL2 is modified to have the interchanged order of the 16-bit color support image processing option ‘contrast adjustment’ and the 8-bit color support image processing option ‘cross filter’. The execution order is accordingly changed to the order of ‘rotation/reversal’, ‘exposure compensation’, ‘contrast adjustment’, and ‘cross filter’. The processing of steps S1390 and S1392 corresponds to the execution order control module 152b (FIG. 10).

Referring back to the flowchart of FIG. 14, after execution of step S1392, the CPU 30 generates retouched image data Dpo, based on the input image data Dpi read in the input process of step S1200, the retouch record file FL1 updated at step S1380, and the execution order storage file FL2 updated at step S1392 (step S1394).

The processing of step S1394 sequentially executes the image processing options registered in the retouch record file FL1 with regard to the input image data Dpi in the execution order stored in the execution order storage file FL2 to generate the retouched image data Dpo. The concrete procedure reads a 1^{st} record in the execution order storage file FL2, sets the data DT4 ‘retouch process number’ included in the 1^{st} record to a retrieval key, and retrieves the data DT2 ‘image processing option’ and DT3 ‘parameter’ corresponding to the data DT4 ‘retouch process number’ from the retouch record file FL1. The procedure then executes the image processing option written in the data DT2 with regard to the input image data Dpi with the parameter written in the data DT3.

Each image processing module receives a parameter corresponding to the operator's operation command and input image data and executes corresponding image processing of the input image data to attain a level of retouching specified by the received parameter. The procedure selects an image processing module corresponding to the image processing option written in the data DT2 and inputs the input image data Dpi and the parameter written in the data DT3 into the selected image processing module. This gives image data processed by the 1^{st} image processing option (hereafter referred to as 1^{st} processed image data) stored in the execution order storage file FL2.

The procedure reads a 2^{nd} record in the execution order storage file FL2, sets the data DT4 ‘retouch process number’ included in the 2^{nd} record to a retrieval key, and retrieves the data DT2 ‘image processing option’ and DT3 ‘parameter’ corresponding to the data DT4 ‘retouch process number’ from the retouch record file FL1. The procedure then executes the image processing option written in the data DT2 with regard to the 1^{st} processed image data with the parameter written in the data DT3. This gives 2^{nd} processed image data or image data processed by the 2^{nd} image processing option. In this manner, the image processing options are sequentially executed to the last image processing option written in the last record stored in the execution order storage file FL2. The procedure executes all the image processing options registered in the execution order storage file FL2 to eventually generate the retouched image data Dpo.

The procedure of this embodiment sequentially executes all the image processing options stored in the execution order storage file FL2 with regard to the input image data Dpi read in the input process of step S1200. One modified procedure may store the location of the newly added image processing option in the rearrangement process of the execution order at step S1392. Processed image data is backed up when each image processing option is executed. The procedure may thus read the processed image data immediately before the location of the newly added image processing option and execute the subsequent image processing options with regard to the processed image data.

After generation of the retouched image data Dpo at step S1394, the CPU 30 displays the retouched image data Dpo in the work field FDW of the application window WD10 (step S1396), and determines whether selection of any of the icons IC101 to IC109 provided in the application window WD10 has been concluded (step S1398). The CPU 30 determines whether any operation command other than the click of the icons IC101 to IC109 has been received. In response to an affirmative answer, the CPU 30 determines that selection of the icons IC101 to IC109 has been concluded and goes to ‘Return’. When it is determined at step S1398 that selection of the icons IC101 to IC109 has not yet been concluded, the CPU 30 returns to step S1340 to execute the image processing option corresponding to the newly selected icon among the icons IC101 to IC109.

B-3. Functions and Effects

As described above, in the computer system of the second embodiment, the retouching process sequentially executes the image processing options with regard to the input image data Dpi read in the input process of step S1200, in response to the operator's click of one of the icons IC101 to IC109. Every time the operator newly clicks a selected icon to specify an additional image processing option, all the stored image processing options including the additional image processing option are rearranged in the specific order that ensures execution of all the 16-bit color support image processing options prior to execution of the 8-bit color support image processing options.

This procedure of the second embodiment restrains image data converted to the 8-bit color from going through the subsequent 16-bit color support image processing. The 16-bit color support image processing thus ensures the expected performances. This arrangement desirably prevents potential deterioration of the picture quality in the retouching process.

B-4. Modifications

The structure of the second embodiment discussed above may be modified in various ways. Some examples of possible modification are given below.

(1) In the second embodiment discussed above, the retouching process includes the image processing options ‘rotation/reversal’, ‘trimming’, ‘exposure compensation’, ‘contrast adjustment’, ‘saturation adjustment’, ‘histogram modification’, ‘unsharp mask’, ‘cross filter’, and ‘inscription’. Other image processing options, for example, color balance adjustment and mosaic, may be added to these options or may be replaced with some of these options. Some of the above image processing options may be omitted if not required. The image processing option ‘color balance adjustment’ is 16-bit color support, and the image processing option ‘mosaic’ is 8-bit color support.

(2) In the second embodiment discussed above, each of the image processing options is classified in one of the 16-bit color support and 8-bit color support. Specific image processing options may be grouped in both the 16-bit color support and the 8-bit color support. For example, the image processing options, trimming and rotation/reversal, do not deteriorate the image information in either the 16-bit color support or the 8-bit color support and may thus be grouped in both the 16-bit color support and the 8-bit color support. When the operator specifies the image processing option ‘rotation/reversal’ or ‘trimming’, the modified procedure attaches an additional record of the newly specified image processing option to the execution order storage file FL2 without any rearrangement. The ‘bit number’ of a last record immediately before the additional record is set to the data DT5 ‘bit number’ of the additional record.

(3) The procedure of the second embodiment applies the bubble sort technique to the rearrangement of step S1394. Any other suitable sort technique, for example, bucket sort, radix sort, heap sort, merge sort, or quick sort, may be adopted for the rearrangement.

(4) In the second embodiment discussed above, the series of image processing is grouped into the 8-bit color support and the 16-bit color support. One possible modification may group the series of image processing into three or a greater number of bit color support groups, for example, 8-bit color support, 16-bit color support, and 24-bit color support.

(5) The input image data Dpi is taken with the digital camera in the structure of the second embodiment, but may otherwise be image data of an analog photograph or photogravure taken with a color scanner or any other suitable means. The input image data Dpi may be stored in advance in a storage device, such as the HDD 42, or may be externally taken via a network. The input image data Dpi may be black and white image data, instead of the color image data.

(6) The input image data Dpi is 16-bit color image data stored in the ‘RAW’ mode in the second embodiment, but may otherwise be 8-bit color image data. The 16-bit color support image processing may output finer values even when the input image has only 8-bit information. Execution of the subsequent 8-bit color support image processing eliminates the finer part of the output values. The technique of the invention is thus effectively applicable to the 8-bit color input image data to collectively execute the 16-bit color support image processing prior to execution of the 8-bit color support image processing and thereby take advantage of the finer part of the output values.

### C. Third Embodiment

A third embodiment of the invention is discussed below.

C-1. System Configuration

The computer system in the third embodiment of the invention has the same hardware configuration as that of the first embodiment shown in FIG. 1. The like numerals to those of the first embodiment denote the like elements.

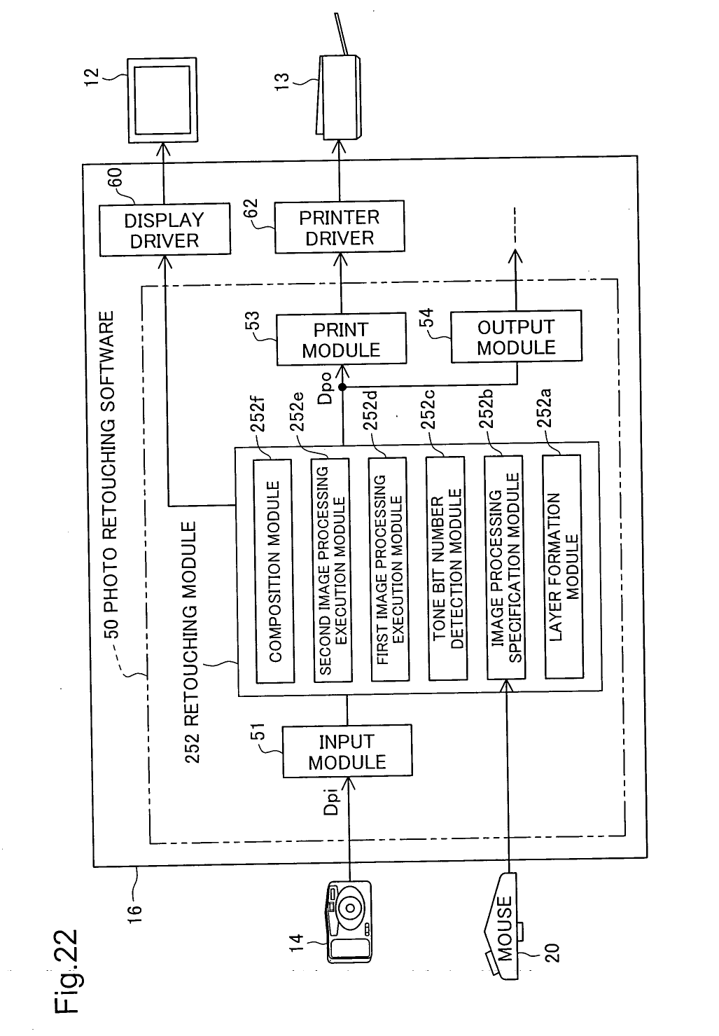

The software configuration of the third embodiment has some differences from that of the first embodiment. FIG. 22 is a block diagram showing a control flow according to the photo retouching software 50 executed by the computer body 16 in the third embodiment. The only difference from the software configuration of the first embodiment shown in FIG. 2 is the constituents of a retouching module 252.

The retouching module 252 of the third embodiment includes a layer formation module 252a, an image processing specification module 252b, a tone bit number detection module 252c, a first image processing execution module 252d, a second image processing execution module 252e, and a composition module 252f. The input image data Dpi is retouched by sequential execution of a series of image processing. The structure of the respective modules 252a through 252f is characteristic of the invention and is described in detail later.

C-2. Computer Processing

C-2-1. General Flow

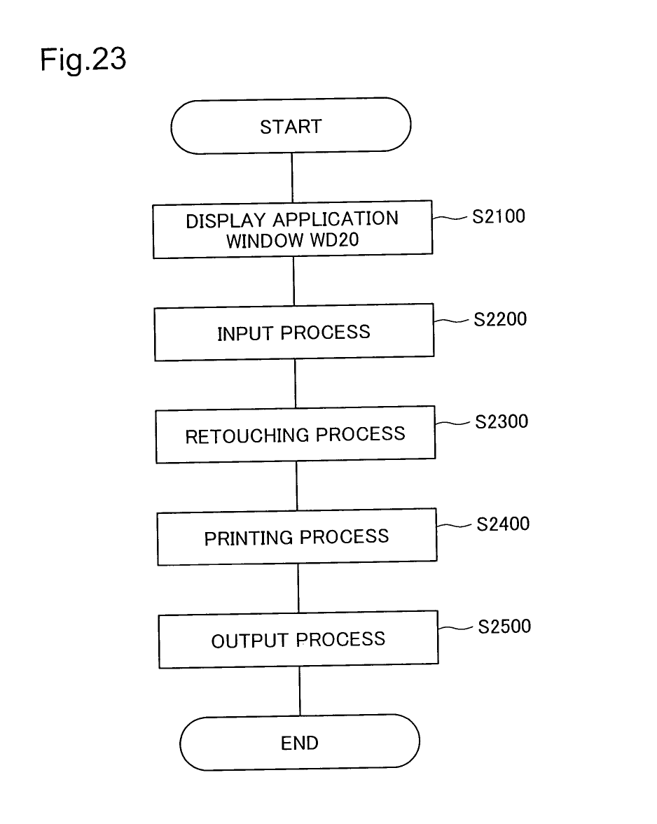

The CPU 30 of the computer body 16 executes the photo retouching software 50 to attain the functions of the input module 51, the retouching module 252, the print module 53, and the output module 54. The series of control according to the photo retouching software 50 is described in detail. FIG. 23 is a flowchart showing a control routine of the third embodiment, which is executed in response to a start instruction of the photo retouching software 50.

As illustrated, the CPU 30 first displays an application window WD20 on the CRT display 12 (step S2100). The initial state of the application window WD20 is identical with the initial state of the application window WD10 of the second embodiment shown in FIG. 12. The CPU 30 receives operation commands given by the operator's clicks of the menu buttons BT101 to BT104 with the mouse 20 after execution of step S2100 and sequentially executes an input process, a retouching process, a printing process, and an output process corresponding to the given operation commands (steps S2200, S2300, S2400, and S2500) in the flowchart of FIG. 23.

The input process executed at step S2200 is identical with the input process of step S200 executed in the first embodiment and corresponds to the input module 51 (see FIG. 22). The printing process executed at step S2400 is identical with the printing process of step S500 executed in the first embodiment and corresponds to the printing module 53 (FIG. 22). The output process executed at step S2500 is identical with the output process of step S600 executed in the first embodiment and corresponds to the output module 54 (FIG. 22).

The retouching process executed at step S2300, which is characteristic of the invention, retouches the input image data Dpi through a series of image processing. The retouched image data Dpo after the image processing is stored in a predetermined folder provided in the HDD 42. This retouching process corresponds to the retouching module 252 (FIG. 22).

C-2-2. Retouching Process

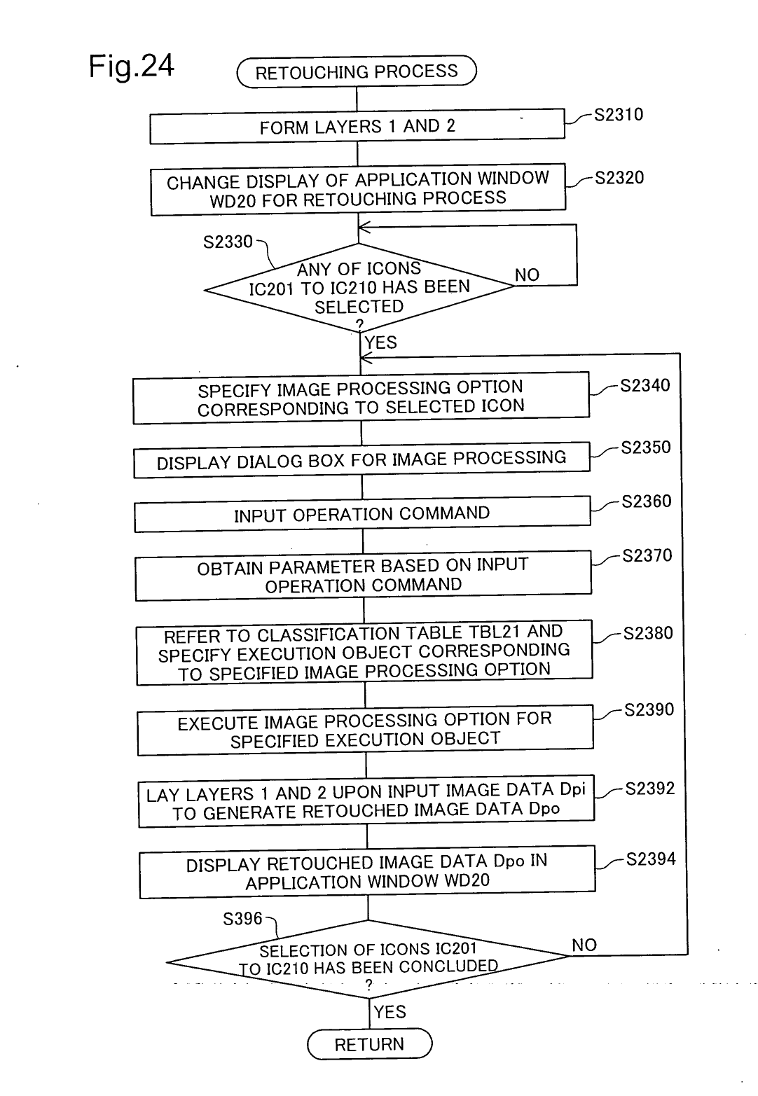

The retouching process executed at step S2300 in the flowchart of FIG. 23 is described in detail. FIG. 24 is a flowchart showing the details of the retouching process. The CPU 30 first forms two layers with regard to the input image data Dpi read in the input process of step S2200 (step S2310). Each layer is a transparent sheet applied to correct the color of the original image (the input image data Dpi) or to mount a new image (for example, characters and clips) on the original image without actually changing the original image.

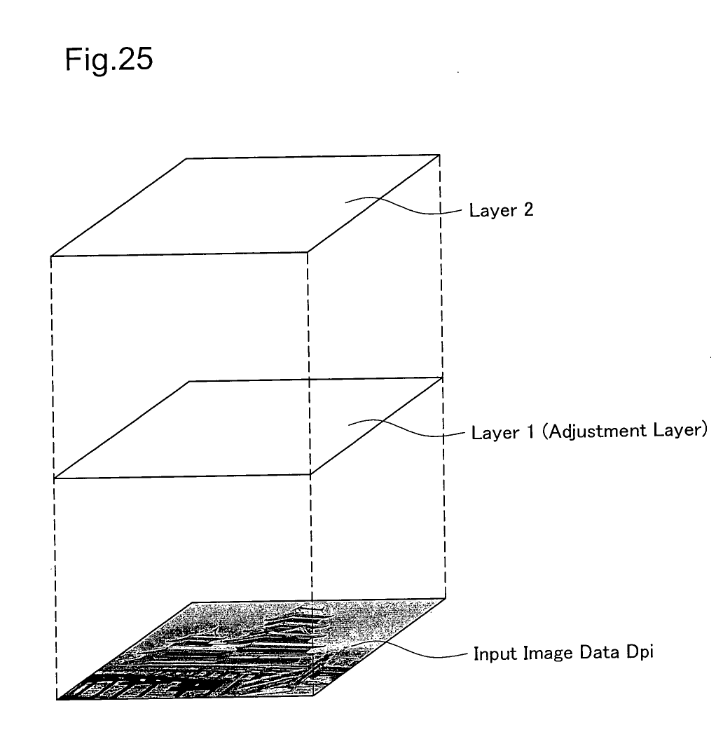

FIG. 25 conceptually shows two layers, layer 1 and layer 2, formed with regard to the input image data Dpi. As illustrated, both the layer 1 and the layer 2 have an identical size with that of the input image data Dpi. The layer 1 and the layer 2 are laid in this order upon the input image data Dpi. There are two different types of layers, that is, a standard layer used to mount a new image for the additional design effect and a special layer used to give a certain effect to the pixels of its lower layer or the input image data Dpi without creation of any new image. The special layer is generally called the adjustment layer. The layer 1 immediately above the input image data Dpi is the adjustment layer, and the layer 2 above the layer 1 is the standard layer.

Referring back to the flowchart of FIG. 24, the CPU 30 changes the display of the application window WD20 for the retouching process on the CRT display 12 (step S2320).

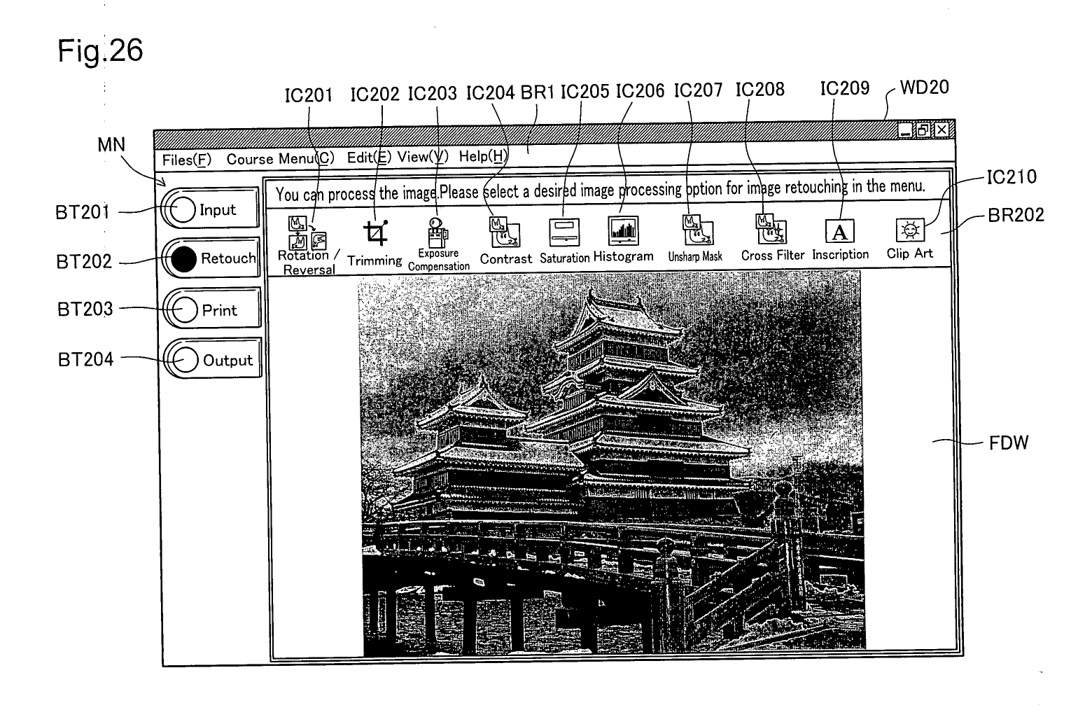

FIG. 26 shows the display of the application window WD20 for the retouching process. As illustrated, a tool bar BR202 in the application window WD20 for the retouching process includes icons IC201 ‘Rotation/Reversal’, IC202 ‘Trimming’, IC203 ‘Exposure Compensation’, IC204 ‘Contrast’, IC205 ‘Saturation’, IC206 ‘Histogram’, IC207 ‘Unsharp Mask’, IC208 ‘Cross Filter’, IC209 ‘Inscription’, and IC210 ‘Clip Art’. The operator manipulates the mouse 20 to selectively click one of the icons IC201 to IC210 and thereby give an execution command of the desired image processing option corresponding to the clicked one of the icons IC201 to IC210.

The icons IC201 to IC210 are instruction switches represented by picture symbols. The instruction switches are not restricted to the icons IC201 to IC210 but may be menu options open from the menu bar BR1.

The image processing options ‘rotation/reversal’, ‘trimming’, ‘exposure compensation’, ‘contrast adjustment’, ‘saturation adjustment’, ‘histogram modification’, ‘unsharp mask’, ‘cross filter’, and ‘inscription’ are the same as those discussed in the second embodiment. The image processing option ‘clip art paste’ mounts or pastes a line art, a pattern, a picture, or any new image on the original image.

Referring back to the flowchart of FIG. 24, after execution of step S2320, the CPU 30 inputs the operator's instruction corresponding to a click of the mouse 20 and determines whether the operator has selected any one of the icons IC201 to IC210 in the application window WD20 (step S2330). In the case of no selection of any of the icons IC201 to IC210, the CPU 30 repeatedly executes the processing of step S2330 and waits for selection of any one of the icons IC201 to IC210.

In response to selection of one of the icons IC201 to IC210 at step S2330, the CPU 30 goes to step S2340. The processing of steps S2340 to S2370 is identical with the processing of steps S1340 to S1370 of the second embodiment shown in the flowchart of FIG. 13.

After execution of step S2370, the CPU 30 specifies an execution object of image processing according to the image processing option specified at step S2340 (step S2380). A classification table TBL21 including various image processing options grouped into multiple execution objects is used for this specification. The classification table TBL21 is written in advance in the photo retouch software 50 and is transferred to and stored in the RAM 32 after activation of the photo retouch software 50.

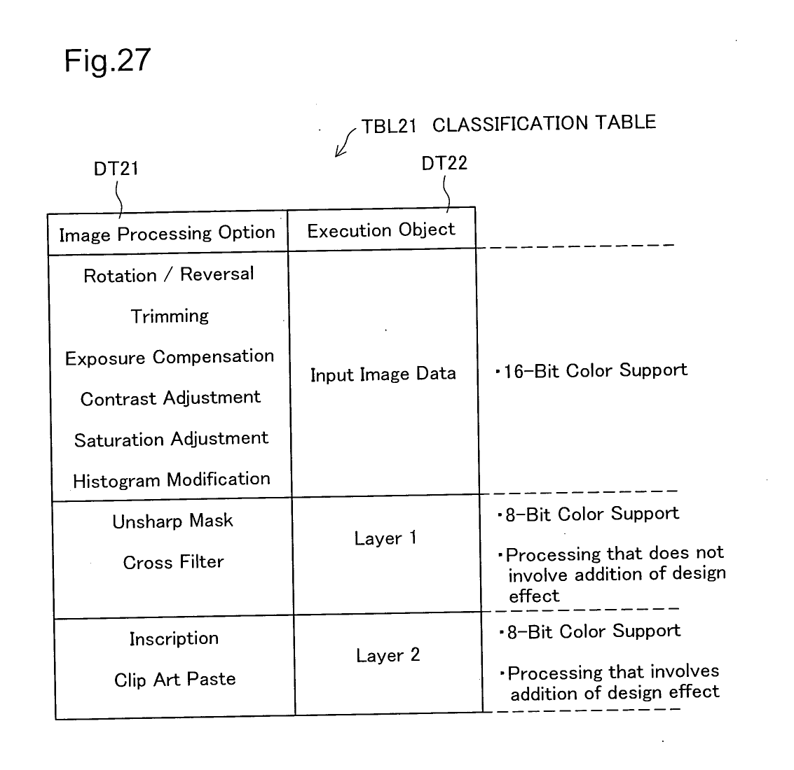

FIG. 27 shows one example of the classification table TBL21. As illustrated, the classification table TBL21 includes data DT21 ‘image processing option’ and DT22 ‘execution object’. The data DT21 ‘image processing option’ includes image processing options executable according to the photo retouch software 50, that is, the image processing options ‘rotation/reversal’, ‘trimming’, ‘exposure compensation’, ‘contrast adjustment’, ‘saturation adjustment’, ‘histogram modification’, ‘unsharp mask’, ‘cross filter’, ‘inscription’, and ‘clip art paste’ registered in the tool bar BR202. The data DT22 ‘execution object’ includes the input image data Dpi, the layer 1, and the layer 2 corresponding to the respective image processing options.

The ten image processing options available in the retouching process are actualized by individual image processing modules in the computer program. There are 16-bit color support modules that process input image data as 16-bit color and 8-bit color support modules that process input image data as 8-bit color. The 16-bit color support and the 8-bit color support are the software design specifications of image processing. The 16-bit color support is selectively used by taking into account the positive effects on the picture quality and the adverse effects on the processing speed and the operational performances of resources. The 16-bit color support is adopted for operations that demand the sufficient volume of information and the sufficient picture quality or operations that are required for foundation of the image, for example, compensation of the exposure and adjustment of the contrast and the saturation, while the 8-bit color support is adopted for the other operations. In this embodiment, the image processing options ‘rotation/reversal’, ‘trimming’, ‘exposure compensation’, ‘contrast adjustment’, ‘saturation adjustment’, and ‘histogram modification’ are the 16-bit color support, while the other image processing options ‘unsharp mask’, ‘cross filter’, ‘inscription’, and ‘clip art paste’ are the 8-bit color support.

In the classification table TBL21, the input image data Dpi is set to the execution object of the 16-bit color support image processing. The execution object of the 8-bit color support image processing depends upon whether the image processing option involves attachment of a new image for the additional design effect. The layer 2 out of the layers formed at step S2310 is set to the execution object of the 8-bit color support image processing that involves attachment of a new image for the additional design effect. The layer 1 out of the layers formed at step S2310 is set to the execution object of the 8-bit color support image processing that does not involve attachment of a new image. In this embodiment, the 8-bit color support image processing options ‘inscription’ and ‘clip art paste’ involve attachment of a new image and are thus related to the layer 2. The other 8-bit color support image processing options ‘unsharp mask’ and ‘cross filter’ are related to the layer 1.

The concrete procedure of step S2380 retrieves the image processing option specified at step S2340 in the data DT21 ‘image processing option’ of the classification table TBL21 and reads the data DT22 ‘execution object’ corresponding to the retrieved image processing option, so as to specify the execution object of the image processing option.

The CPU 30 then executes the image processing option specified at step S2340 with regard to the execution object specified at step S2380 with the parameter obtained at step S2370 (step S2390). When the specified execution object is the input image data Dpi at step S2380, the image processing option specified at step S2340 is executed with regard to the input image data Dpi with the parameter obtained at step S2370. When the specified execution object is the layer 1 at step S2380, the image processing option specified at step S2340 is executed with regard to the layer 1 with the parameter obtained at step S2370. When the specified execution object is the layer 2 at step S2380, the image processing option specified at step S2340 is executed with regard to the layer 2 with the parameter obtained at step S2370.

When the image processing option specified by the operator's click of one of the icons IC201 to IC210 is any of ‘rotation/reversal’, ‘trimming’, ‘exposure compensation’, ‘contrast adjustment’, ‘saturation adjustment’, and ‘histogram modification’, the input image data Dpi is directly processed by the specified image processing option.

When the image processing option specified by the operator's click of one of the icons IC201 to IC210 is either of ‘unsharp mask’ and ‘cross filter’, the specified image processing option is executed for the layer 1. The layer 1 is the adjustment layer as mentioned above. The concrete procedure sets the color correction effect as the ‘unsharp mask’ effect or the ‘cross filter’ effect on the layer 1 and registers the specified image processing option (step S2340) and the obtained parameter (step S2370) as retouch information into the layer 1.

When the image processing option specified by the operator's click of one of the icons IC201 to IC210 is either of ‘inscription’ and ‘clip art paste’, the specified image processing option is executed for the layer 2. The concrete procedure writes a character string or an image to be mounted by ‘inscription’ or ‘clip art paste’ onto the layer 2.

After execution of step S2390, the CPU 30 lays the layer 1 and layer 2 upon the input image data Dpi read in the input process of step S2200 in this order to generate composite image data as retouched image data Dpo (step S2392). The retouched image data Dpo eventually generated by such combination has the image processing effects of the layers 1 and 2 reflected on the input image data Dpi.

After generation of the retouched image data Dpo at step S2392, the CPU 30 displays the retouched image data Dpo in the work field FDW of the application window WD20 (step S2394), and determines whether selection of any of the icons IC201 to IC210 provided in the application window WD20 has been concluded (step S2396). The CPU 30 determines whether any operation command other than the click of the icons IC201 to IC210 has been received. In response to an affirmative answer, the CPU 30 determines that selection of the icons IC201 to IC210 has been concluded and goes to ‘Return’. When it is determined at step S2396 that selection of the icons IC201 to IC210 has not yet been concluded, the CPU 30 returns to step S2340 to execute the image processing option corresponding to the newly selected icon among the icons IC201 to IC210.

The processing of step S2310 executed by the CPU 30 corresponds to the layer formation module 252a (see FIG. 22). The processing of steps S2330 and S2340 executed by the CPU 30 corresponds to the image processing specification module 252b (FIG. 22).

The processing of steps S2350 to S2390 executed by the CPU 30 and the classification table TBL21 correspond to the tone bit number detection module 252c, the first image processing execution module 252d, and the second image processing execution module 252e (FIG. 22). In the structure of this embodiment, the processing of step S2380 to refer to the classification table TBL21 implements the function of the tone bit number detection module 252c. The processing of step S2390 implements the functions of the first image processing execution module 252d and the second image processing execution module 252e. The retouching routine (program) of the embodiment using the classification table TBL21 may be modified to individually determine the type of the image processing option and execute the image processing option with regard to the corresponding execution object. This modified retouching routine has step A that determines whether the image processing option corresponding to a selected icon is any of ‘rotation/reversal’, ‘trimming’, ‘exposure compensation’, ‘contrast adjustment’, ‘saturation adjustment’, and ‘histogram modification’, step B that determines whether the image processing option corresponding to a selected icon is either of ‘unsharp mask’ and ‘cross filter’, and step C that determines whether the image processing option corresponding to a selected icon is either of ‘inscription’ and ‘clip art paste’. In the case of an affirmative answer at step A, the specified image processing option is executed for the input image data Dpi. In the case of an affirmative answer at step B, the specified image processing option is executed for the layer 1. In the case of an affirmative answer at step C, the specified image processing option is executed for the layer 2.

The processing of step S2392 executed by the CPU 30 corresponds to the combination module 252f (see FIG. 22).

C-3. Functions and Effects

As described above, in the computer system of the third embodiment, the retouching process sequentially executes the image processing options with regard to the input image data Dpi read in the input process of step S2200, in response to the operator's click of one of the icons IC201 to IC210. When the image processing option specified by the click of the selected icon is the 16-bit color support, the specified image processing option is directly executed for the input image data Dpi. When the specified image processing option is the 8-bit color support, the specified image processing option is executed for either the layer 1 or the layer 2. This arrangement collectively executes the 16-bit color support image processing prior to execution of the 8-bit color support image processing with regard to the layers 1 and 2.

This procedure of the third embodiment restrains image data converted to the 8-bit color from going through the subsequent 16-bit color support image processing. The 16-bit color support image processing thus ensures the expected performances. This arrangement desirably prevents potential deterioration of the picture quality in the retouching process.

In the structure of the third embodiment, the 8-bit color support image processing options are further divided by the execution object and are grouped into the layer 2 used for the image processing that involves attachment of a new image for the additional design effect and the layer 1 used for the image processing that does not involve attachment of a new image. The image processing option that involves attachment of a new image for the additional design effect masks at least part of the input image data Dpi located immediately below the attached new image. Subsequent image processing may accordingly not give the desired effects to the input image data Dpi. The procedure of the third embodiment executes the image processing that does not involve attachment of a new image on the lower layer 1 prior to execution of the image processing that involves attachment of a new image. This desirably prevents the effect of the image processing that does not involve attachment of a new image from being damaged by subsequent image processing that involves attachment of a new image.

The structure of the third embodiment may be modified to use only one layer. In this modified structure, the layer 1 is set to the execution object of all the 8-bit color support image processing options.

### D. Fourth Embodiment

A fourth embodiment of the invention is discussed below. The structure of the fourth embodiment is basically identical with the structure of the third embodiment, except the number of layers and the contents of the classification table.

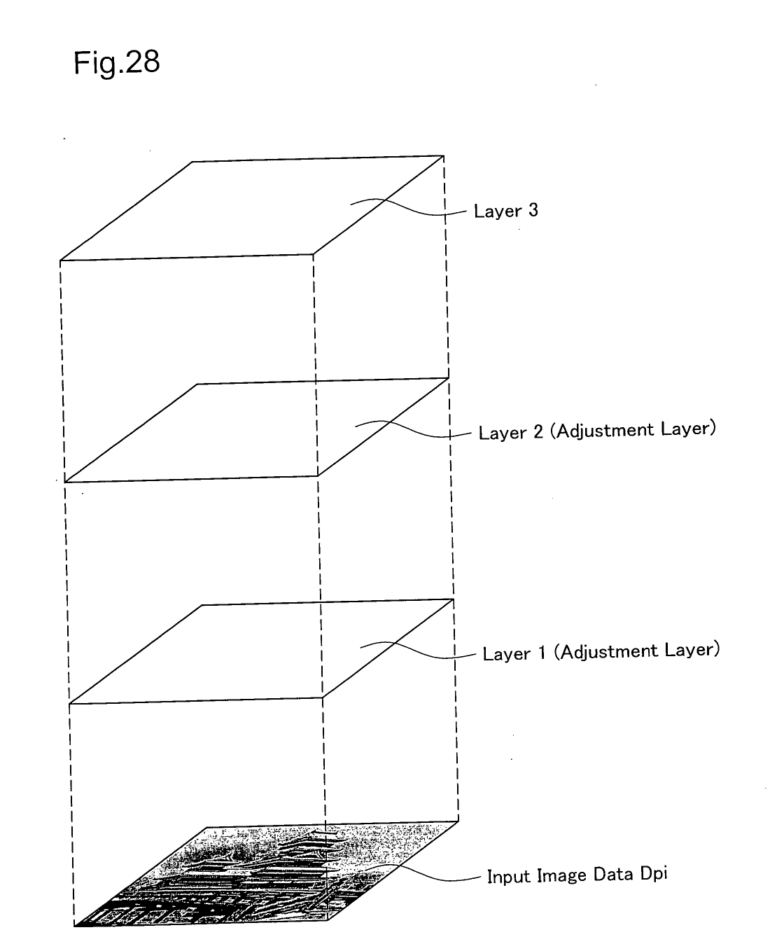

The fourth embodiment forms three layers, instead of the two layers 1 and 2. FIG. 28 conceptually shows three layers, layer 1, layer 2, and layer 3, formed with regard to the input image data Dpi. As illustrated, all the layers 1 to 3 have an identical size with that of the input image data Dpi. The layer 1, the layer 2, and the layer 3 are laid in this order upon the input image data Dpi. In this embodiment, the layer 1 and the layer 2 are adjustment layers, while the layer 3 is a standard layer.

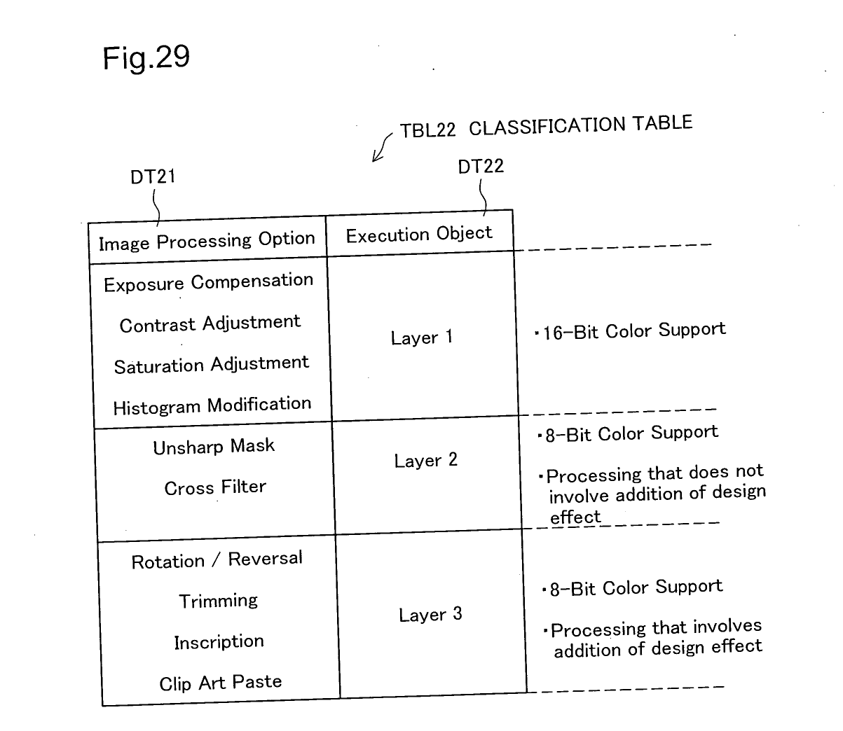

FIG. 29 shows a classification table TBL22 used in the fourth embodiment. The differences from the classification table TBL21 of the third embodiment are that the layer 1 is set to the execution object of the 16-bit color support image processing, that the layer 2 is set to the execution object of the 8-bit color support image processing that does not involve addition of the design effect, and that the layer 3 is set to the execution object of the 8-bit color support image processing that involves addition of the design effect. The image processing options ‘rotation/reversal’ and ‘trimming’ are grouped in the lower-most layer in the classification table TBL21 of the third embodiment, but are grouped in the upper-most layer in the classification table TBL22 of the fourth embodiment.

The image processing options ‘rotation/reversal’ and ‘trimming’ are shifted to the upper-most layer, because of the following reasons. The image processing options ‘rotation/reversal’ and ‘trimming’ are the 16-bit color support but do not significantly deteriorate the image information even when being executed as the 8-bit color support. These image processing options are generally not suitable for the adjustment layer, since the adjustment layer is mainly used for color correction. It is accordingly desirable to execute the image processing options ‘rotation/reversal’ and ‘trimming’ on the standard layer. In the structure of the fourth embodiment, the standard layer 3 is accordingly set to the execution object of the image processing options ‘rotation/reversal’ and ‘trimming’. In one possible modification of the fourth embodiment, the execution object of the image processing options ‘rotation/reversal’ and ‘trimming’ may be changed to the adjustment layer 1, which is modified to execute these image processing options.

The structure of the fourth embodiment forms the three layers. In the retouching process of the fourth embodiment (see FIG. 24), the CPU 30 forms the layer 1, the layer 2, and the layer 3 at step S2310 and lays the layer 1, the layer 2, and the layer 3 upon the input image data Dpi in this order to generate composite image data as the retouched image data Dpo at step S2392.

As described above, in the computer system of the fourth embodiment, when the image processing option specified by the click of one of the icons IC201 to IC210 is any of ‘exposure compensation’, ‘contrast adjustment’, ‘saturation adjustment’, and ‘histogram modification’, the specified image processing option is executed for the lower-most adjustment layer 1. When the specified image processing option is either of ‘unsharp mask’ and ‘cross filter’, the specified image processing option is executed for the middle adjustment layer 2. When the specified image processing option is any of ‘rotation/reversal’, ‘trimming’, ‘inscription’, and ‘clip art paste’, the specified image processing option is executed for the upper-most standard layer 3.

In the structure of the fourth embodiment, the 16-bit color support image processing is executed for the lower-most layer 1 among the three layers. The 8-bit color support image processing is executed, on the other hand, for the middle layer 2 and the upper-most layer 3 among the three layers. This arrangement collectively executes the 16-bit color support image processing prior to execution of the 8-bit color support image processing. This procedure of the fourth embodiment restrains image data converted to the 8-bit color from going through the subsequent 16-bit color support image processing. The 16-bit color support image processing thus ensures the expected performances. This arrangement desirably prevents potential deterioration of the picture quality in the retouching process.

In the structure of the fourth embodiment, the 8-bit color support image processing options are further divided by the execution object and are grouped into the layer 3 used for the image processing that involves attachment of a new image for the additional design effect and the layer 2 used for the image processing that does not involve attachment of a new image. The image processing option that involves attachment of a new image for the additional design effect masks at least part of the input image data Dpi located below the attached new image. Subsequent image processing may accordingly not give the desired effects to the input image data Dpi. The procedure of the fourth embodiment executes the image processing that does not involve attachment of a new image on the lower layer 2 prior to execution of the image processing that involves attachment of a new image. This desirably prevents the effect of the image processing that does not involve attachment of a new image from being damaged by subsequent image processing that involves attachment of a new image.

The structure of the fourth embodiment may be modified to use two layers. In this modified structure, the layer 2 is set to the execution object of all the 8-bit color support image processing options.

E. Modifications

The third and the fourth embodiments discussed above may be modified in various ways.

(1) In the third and the fourth embodiments, the image processing options available in the retouching process include ‘rotation/reversal’, ‘trimming’, ‘exposure compensation’, ‘contrast adjustment’, ‘saturation adjustment’, ‘histogram modification’, ‘unsharp mask’, ‘cross filter’, ‘inscription’, and ‘clip art paste’. Other image processing options, for example, ‘color/white balance adjustment’, ‘tone curve adjustment’, ‘limb darkening correction’, ‘mosaic/embossing’, and ‘lighting effect’, may be added to these options or may be replaced with some of these options. Some of the above image processing options may be omitted if not required. The additional image processing options ‘color/white balance adjustment’, ‘tone curve adjustment’, and ‘limb darkening correction’ are the 16-bit color support image processing. The other additional image processing options ‘mosaic/embossing’ and ‘lighting effect’ are the 8-bit color support image processing that does not involve addition of the design effect. The additional image processing options may be 8-bit color support image processing that involves addition of the design effect, for example, photograph composition.

(2) In the third and the fourth embodiments, the series of image processing is grouped into the 8-bit color support and the 16-bit color support. One possible modification may group the series of image processing into three or a greater number of bit color support groups, for example, 8-bit color support, 16-bit color support, and 24-bit color support. The procedure of this modified example forms three layers, layer 1, layer 2, and layer 3 in this order on the input image data. The execution object of the 24-bit color support image processing is set to the input image data. The execution object of the 16-bit color support image processing is set to the layer 1. The execution object of the 8-bit color support image processing depends upon the type of the image processing with or without addition of the design effect and is set to either the layer 3 or the layer 2.

This modified procedure executes the series of image processing in the sequence of the 24-bit color support, 16-bit color support, and the 8-bit color support. This arrangement restrains image data converted to the 8-bit color from going through the subsequent 16-bit color support image processing or the subsequent 24-bit color support image processing, while restraining image data converted to the 16-bit color from going through the subsequent 24-bit color support image processing. The 16-bit color support image processing and the 24-bit color support image processing thus ensure the expected performances. This arrangement desirably prevents potential deterioration of the picture quality in the retouching process.

(3) In a further modification of the modified example discussed in (2), the layer 2 may be set to the execution object of all the 8-bit color support image processing options. This modification requires two layers.

(4) Another modified example may form four layers, layer 1, layer 2, layer 3, and layer 4 in this order on the input image data. The execution object of the 24-bit color support image processing is set to the layer 1. The execution object of the 16-bit color support image processing is set to the layer 2. The execution object of the 8-bit color support image processing depends upon the type of the image processing with or without addition of the design effect and is set to either the layer 4 or the layer 3. This modified procedure also executes the series of image processing in the sequence of the 24-bit color support, 16-bit color support, and the 8-bit color support. As in the modified example discussed in (2), the 16-bit color support image processing and the 24-bit color support image processing ensure the expected performances. This arrangement desirably prevents potential deterioration of the picture quality in the retouching process.

(5) In a further modification of the modified example discussed in (4), the layer 3 may be set to the execution object of all the 8-bit color support image processing options. This modification requires three layers.

(6) The input image data Dpi is taken with the digital camera in the third and the fourth embodiments discussed above, but may otherwise be image data of an analog photograph or photogravure taken with a color scanner or any other suitable means. The input image data Dpi may be stored in advance in a storage device, such as the HDD 42, or may be externally taken via a network. The input image data Dpi may be black and white image data, instead of the color image data.

(7) The input image data Dpi is 16-bit color image data stored in the ‘RAW’ mode in the third and the fourth embodiments, but may otherwise be 8-bit color image data. The 16-bit color support image processing may output finer values even when the input image has only 8-bit information. Execution of the subsequent 8-bit color support image processing eliminates the finer part of the output values. The technique of the invention is thus effectively applicable to the 8-bit color input image data to collectively execute the 16-bit color support image processing prior to execution of the 8-bit color support image processing and thereby take advantage of the finer part of the output values.

The firs through the fourth embodiments and their modifications discussed above are to be considered in all aspects as illustrative and not restrictive. There may be many modifications, changes, and alterations without departing from the scope or spirit of the main characteristics of the present invention. For example, the arrangement of the first embodiment prohibits execution of the 16-bit color support image processing after execution of the 8-bit color support image processing. The arrangement of the second embodiment updates the execution order to execute the 16-bit color support image processing prior to execution of the 8-bit color support image processing. The arrangement of the third embodiment collectively executes the 16-bit color support image processing with regard to the input image data prior to execution of the 8-bit color support image processing with regard to the layer. These arrangements may be modified in various ways. In general, the procedure of the present invention executes at least two image processing options in a preset order with regard to input image data, based on the tone bit numbers of the respective image processing options and the result of classification of multiple image processing options by the tone bit number.

All changes within the meaning and range of equivalency of the claims are intended to be embraced therein. The scope and spirit of the present invention are indicated by the appended claims, rather than by the foregoing description.

1. An image processing apparatus that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing apparatus comprising:
a classification storage module that stores in advance a result of classification of the multiple image processing options into plural groups by the tone bit number;
a tone bit number detection module that, in response to an execution instruction of a next image processing option after execution of a specific image processing option with regard to the input image data, refers to the result of classification stored in said classification storage module and determines whether the next image processing option is supposed to process image data of a greater tone bit number than a tone bit number of image data processed by the specific image processing option; and
an image processing prohibition module that prohibits execution of the next image processing option when said tone bit number detection module determines that the next image processing option is supposed to process the image data of the greater tone bit number.

2. An image processing apparatus in accordance with claim 1, said image processing apparatus further comprising:
a display module;
a first display control module that displays plural group switches respectively corresponding to the plural groups of classification stored in said classification storage module, on said display module; and
a second display control module that, in response to an operator's operation command of activating one of the multiple group switches, displays an image processing option switch for execution of an image processing option included in a group corresponding to the activated group switch, on said display module,
wherein said tone bit number detection module receives the operator's operation command of activating another group switch, which is different from a specific group switch corresponding to a specific group including the specific image processing option, as the execution instruction of the next image processing option and carries out the determination, based on another group corresponding to the activated another group switch.

3. An image processing apparatus in accordance with claim 2, wherein said first display control module sets a descending order of the tone bit numbers of the plural groups in said classification storage module to a display order of the plural group switches respectively corresponding to the plural groups.

4. An image processing apparatus in accordance with claim 1, wherein said image processing prohibition module comprises a notification module that notifies an operator of prohibited execution of the next image processing.

5. An image processing apparatus that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing apparatus comprising:
a display module;
a classification storage module that stores in advance a result of classification of the multiple image processing options into plural groups by the tone bit number;
a first display control module that displays plural group switches respectively corresponding to the plural groups of classification stored in said classification storage module, on said display module in a descending order of the tone bit numbers of the plural groups corresponding to the plural group switches; and
a second display control module that, in response to an operator's operation command of activating one of the multiple group switches, displays an image processing option switch for execution of an image processing option included in a group corresponding to the activated group switch, on said display module.

6. An image processing apparatus in accordance with claim 1 or 5, wherein the different tone bit numbers expressible in each pixel are 16 bits and 8 bits.

7. An image processing apparatus that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing apparatus comprising:
a classification storage module that stores in advance a result of classification of the multiple image processing options into plural groups by the tone bit number; and
an execution order control module that sets an execution order of the at least two image processing options to be equivalent to a descending order of the tone bit numbers of the image data processed by the at least two image processing options, based on the result of classification stored in said classification storage module.

8. An image processing apparatus in accordance with claim 7, said image processing apparatus further comprising:
an image processing specification module that sequentially specifies the at least two image processing options to be executed for the input image data, in response to an operator's operation instructions;
a parameter acquisition module that, every time said image processing specification module specifies one image processing option, obtains a parameter representing a retouch degree of the specified image processing option in response to the operator's operation command;
a retouch record update module that, every time said image processing specification module specifies one image processing option, adds the specified image processing option with the corresponding parameter obtained by said parameter acquisition module, to a retouch record file; and
an image processing execution module that, every time said image processing specification module specifies one image processing option, generates output image data as a retouch result, based on the input image data, the retouch record file, and the execution order set by said execution order control module.

9. An image processing apparatus in accordance with claim 8, said image processing apparatus further comprising:
a display device;
an input device that receives entry of the operator's operation; and
a display control module that displays a screen area for data input on said display device,
said display control module comprising:
an instruction switch display control module that provides multiple instruction switches in the screen area to receive the operator's operation instruction in said image processing specification module, where the multiple instruction switches correspond to the multiple image processing options; and
an output image data display control module that displays the output image data generated by said image processing execution module, in the screen area.

10. An image processing apparatus in accordance with claim 7, wherein the different tone bit numbers expressible in each pixel are 16 bits and 8 bits.

11. An image processing apparatus that sequentially executes at least two image processing options, which are selected among multiple image processing options provided in advance, with regard to input image data to retouch the input image data,
wherein each of the multiple image processing options is designed to process image data of a preset tone bit number, which is expressible in each pixel and is equal to either of a first value and a second value that is smaller than the first value,
said image processing apparatus comprising:
a layer formation module that forms a layer to make a result of an image processing option reflected on the input image data;
an image processing specification module that specifies a preset image processing option selected among the multiple image processing options with regard to the input image data, in response to an operator's operation instruction;
a tone bit number detection module that determines whether the tone bit number of image data processed by the preset image processing option, which is specified by said image processing specification module, is equal to the first value or the second value;
a first image processing execution module that executes the preset image processing option with regard to the input image data, when said tone bit number detection module determines that the tone bit number of the image data processed by the preset image processing option is equal to the first value;
a second image processing execution module that executes the preset image processing option with regard to the layer, when said tone bit number detection module determines that the tone bit number of the image data processed by the preset image processing option is equal to the second value; and
a composition module that lays the layer upon the input image data to generate composite image data.

12. An image processing apparatus in accordance with claim 11, wherein said layer formation module forms a first layer and a second layer to be laid upon the input image data in this order,
said second image processing execution module comprising:
a processing type determination module that determines whether the preset image processing option is a type of image processing option that involves attachment of a new image for additional design effect;
a first layer execution module that executes the preset image processing option with regard to the first layer, when said tone bit number detection module determines that the tone bit number of the image data processed by the preset image processing option is equal to the second value and when said processing type determination module determines that the preset image processing option is not the type of image processing option that involves attachment of a new image for additional design effect; and
a second layer execution module that executes the preset image processing option with regard to the second layer, when said tone bit number detection module determines that the tone bit number of the image data processed by the preset image processing option is equal to the second value and when said processing type determination module determines that the preset image processing option is the type of image processing option that involves attachment of a new image for additional design effect.

13. An image processing apparatus that sequentially executes at least two image processing options, which are selected among multiple image processing options provided in advance, with regard to input image data to retouch the input image data,
wherein each of the multiple image processing options is designed to process image data of a preset tone bit number, which is expressible in each pixel and is equal to either of a first value and a second value that is smaller than the first value,
said image processing apparatus comprising:
a layer formation module that forms multiple layers to make results of image processing options reflected on the input image data;
an image processing specification module that specifies a preset image processing option selected among the multiple image processing options with regard to the input image data, in response to an operator's operation instruction;
a tone bit number detection module that determines whether the tone bit number of image data processed by the preset image processing option, which is specified by said image processing specification module, is equal to the first value or the second value;
a first image processing execution module that executes the preset image processing option with regard to a lower-most layer among the multiple layers, when said tone bit number detection module determines that the tone bit number of the image data processed by the preset image processing option is equal to the first value;
a second image processing execution module that executes the preset image processing option with regard to a layer other than the lower-most layer among the multiple layers, when said tone bit number detection module determines that the tone bit number of the image data processed by the preset image processing option is equal to the second value; and
a composition module that successively lays the multiple layers upon the input image data to generate composite image data.

14. An image processing apparatus in accordance with claim 13, wherein said layer formation module forms a first layer, a second layer, and a third layer to be laid upon the input image data in this order,
said second image processing execution module comprising:
a processing type determination module that determines whether the preset image processing option is a type of image processing option that involves attachment of a new image for additional design effect;
a first layer execution module that executes the preset image processing option with regard to the second layer, when said tone bit number detection module determines that the tone bit number of the image data processed by the preset image processing option is equal to the second value and when said processing type determination module determines that the preset image processing option is not the type of image processing option that involves attachment of a new image for additional design effect; and
a second layer execution module that executes the preset image processing option with regard to the third layer, when said tone bit number detection module determines that the tone bit number of the image data processed by the preset image processing option is equal to the second value and when said processing type determination module determines that the preset image processing option is the type of image processing option that involves attachment of a new image for additional design effect.

15. An image processing apparatus that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing apparatus comprising:
a layer formation module that forms multiple layers to make results of image processing options reflected on the input image data;
a classification storage module that stores in advance information representing classification of the multiple image processing options into plural groups by the tone bit number, where the information relates the input image data to a specified group of a greatest tone bit number among the plural groups, while respectively relating the multiple layers to residual groups other than the specified group among the plural groups such that an upper layer corresponds to a smaller tone bit number;
an image processing specification module that specifies a preset image processing option selected among the multiple image processing options with regard to the input image data, in response to an operator's operation instruction;
a layer detection module that refers to the information stored in said classification storage module and selects an execution object of the preset image processing specified by said image processing specification module among the input image data and the multiple layers;
an image processing execution module that executes the preset image processing option specified by said image processing specification module with regard to the selected one of the input image data and the multiple layers by said layer detection module; and
a composition module that successively lays the multiple layers upon the input image data to generate composite image data.

16. An image processing apparatus that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing apparatus comprising:
a layer formation module that forms multiple layers to make results of image processing options reflected on the input image data;
a classification storage module that stores in advance information representing classification of the multiple image processing options into plural groups by the tone bit number, where the information respectively relates the multiple layers to the plural groups such that an upper layer corresponds to a smaller tone bit number;
an image processing specification module that specifies a preset image processing option selected among the multiple image processing options with regard to the input image data, in response to an operator's operation instruction;
a layer detection module that refers to the information stored in said classification storage module and selects an execution object of the preset image processing specified by said image processing specification module among the multiple layers formed by the layer formation module;
an image processing execution module that executes the preset image processing option specified by said image processing specification module with regard to the selected one of the multiple layers by said layer detection module; and
a composition module that successively lays the multiple layers upon the input image data to generate composite image data.

17. An image processing apparatus that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing apparatus comprising:
a classification storage module that stores in advance a result of classification of the multiple image processing options into plural groups by the tone bit number; and
a processing module that executes the at least two image processing options in a preset order with regard to the input image data, based on the tone bit numbers of the respective image processing options and the result of classification stored in said classification storage module.

18. An image processing method that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing method comprising the steps of:
(a) storing a result of classification of the multiple image processing options into plural groups by the tone bit number;
(b) in response to an execution instruction of a next image processing option after execution of a specific image processing option with regard to the input image data, referring to the result of classification stored in said step (a) and determining whether the next image processing option is supposed to process image data of a greater tone bit number than a tone bit number of image data processed by the specific image processing option; and
(c) prohibiting execution of the next image processing option when it is determined in said step (b) that the next image processing option is supposed to process the image data of the greater tone bit number.

19. An image processing method in accordance with claim 18, said image processing method further comprising the steps of:
(d) displaying plural group switches respectively corresponding to the plural groups of classification stored in said step (a), on a display unit; and
(e) in response to an operator's operation command of activating one of the multiple group switches, displaying an image processing option switch for execution of an image processing option included in a group corresponding to the activated group switch, on the display unit,
wherein said step (b) receives the operator's operation command of activating another group switch, which is different from a specific group switch corresponding to a specific group including the specific image processing option, as the execution instruction of the next image processing option and carries out the determination, based on another group corresponding to the activated another group switch.

20. An image processing method that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing method comprising the steps of:
(a) storing a result of classification of the multiple image processing options into plural groups by the tone bit number;
(b) displaying plural group switches respectively corresponding to the plural groups of classification stored in said step (a), on a display unit in a descending order of the tone bit numbers of the plural groups corresponding to the plural group switches; and
(c) in response to an operator's operation command of activating one of the multiple group switches, displaying an image processing option switch for execution of an image processing option included in a group corresponding to the activated group switch, on the display unit.

21. An image processing method that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing method comprising the steps of:
(a) storing a result of classification of the multiple image processing options into plural groups by the tone bit number; and
(b) setting an execution order of the at least two image processing options to be equivalent to a descending order of the tone bit numbers of the image data processed by the at least two image processing options, based on the result of classification stored in said step (a).

22. An image processing method in accordance with claim 21, said image processing method further comprising the steps of:
(c) sequentially specifying the at least two image processing options to be executed for the input image data, in response to an operator's operation instructions;
(d) every time one image processing option is specified in said step (c), obtaining a parameter representing a retouch degree of the specified image processing option in response to the operator's operation command;
(e) every time one image processing option is specified in said step (c), adding the specified image processing option with the corresponding parameter obtained in said step (d), to a retouch record file; and
(f) every time one image processing option is specified in said step (c), generating output image data as a retouch result, based on the input image data, the retouch record file, and the execution order set in said step (b).

23. An image processing method that sequentially executes at least two image processing options, which are selected among multiple image processing options provided in advance, with regard to input image data to retouch the input image data,
wherein each of the multiple image processing options is designed to process image data of a preset tone bit number, which is expressible in each pixel and is equal to either of a first value and a second value that is smaller than the first value,
said image processing method comprising the steps of:
(a) forming a layer to make a result of an image processing option reflected on the input image data;
(b) specifying a preset image processing option selected among the multiple image processing options with regard to the input image data, in response to an operator's operation instruction;
(c) determining whether the tone bit number of image data processed by the preset image processing option, which is specified in said step (b), is equal to the first value or the second value;
(d) executing the preset image processing option with regard to the input image data, when it is determined in said step (c) that the tone bit number of the image data processed by the preset image processing option is equal to the first value;
(e) executing the preset image processing option with regard to the layer, when it is determined in said step (c) that the tone bit number of the image data processed by the preset image processing option is equal to the second value; and
(f) laying the layer upon the input image data to generate composite image data.

24. An image processing method that sequentially executes at least two image processing options, which are selected among multiple image processing options provided in advance, with regard to input image data to retouch the input image data,
wherein each of the multiple image processing options is designed to process image data of a preset tone bit number, which is expressible in each pixel and is equal to either of a first value and a second value that is smaller than the first value,
said image processing method comprising the steps of:
(a) forming multiple layers to make results of image processing options reflected on the input image data;
(b) specifying a preset image processing option selected among the multiple image processing options with regard to the input image data, in response to an operator's operation instruction;
(c) determining whether the tone bit number of image data processed by the preset image processing option, which is specified in said step (b), is equal to the first value or the second value;
(d) executing the preset image processing option with regard to a lower-most layer among the multiple layers, when it is determined in said step (c) that the tone bit number of the image data processed by the preset image processing option is equal to the first value;
(e) executing the preset image processing option with regard to a layer other than the lower-most layer among the multiple layers, when it is determined in said step (c) that the tone bit number of the image data processed by the preset image processing option is equal to the second value; and
(f) successively laying the multiple layers upon the input image data to generate composite image data.

25. An image processing method that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing method comprising the steps of:
(a) forming multiple layers to make results of image processing options reflected on the input image data;
(b) storing information representing classification of the multiple image processing options into plural groups by the tone bit number, where the information relates the input image data to a specified group of a greatest tone bit number among the plural groups, while respectively relating the multiple layers to residual groups other than the specified group among the plural groups such that an upper layer corresponds to a smaller tone bit number;
(c) specifying a preset image processing option selected among the multiple image processing options with regard to the input image data, in response to an operator's operation instruction;
(d) referring to the information stored in said step (b) and selecting an execution object of the preset image processing specified in said step (c) among the input image data and the multiple layers;
(e) executing the preset image processing option specified in said step (c) with regard to the selected one of the input image data and the multiple layers in said step (d); and
(f) successively laying the multiple layers upon the input image data to generate composite image data.

26. An image processing method that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing method comprising the steps of:
(a) forming multiple layers to make results of image processing options reflected on the input image data;
(b) storing information representing classification of the multiple image processing options into plural groups by the tone bit number, where the information respectively relates the multiple layers to the plural groups such that an upper layer corresponds to a smaller tone bit number;
(c) specifying a preset image processing option selected among the multiple image processing options with regard to the input image data, in response to an operator's operation instruction;
(d) referring to the information stored in said step (b) and selecting an execution object of the preset image processing specified in said step (c) among the multiple layers formed in said step (a);
(e) executing the preset image processing option specified in said step (c) with regard to the selected one of the multiple layers in said step (d); and
(f) successively laying the multiple layers upon the input image data to generate composite image data.

27. An image processing method that sequentially executes at least two image processing options, which are selected among multiple image processing options provided in advance, with regard to input image data to retouch the input image data,
wherein the multiple image processing options are designed to process image data of different tone bit numbers expressible in each pixel,
said image processing method comprising the steps of:
(a) storing a result of classification of the multiple image processing options into plural groups by the tone bit number; and
(b) executing the at least two image processing options in a preset order with regard to the input image data, based on the tone bit numbers of the respective image processing options and the result of classification stored in said step (a).

28. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein the multiple image processing options are designed to process image data of different tone bit numbers expressible in each pixel,
said computer program comprising:
(a) a first program for causing a computer to store a result of classification of the multiple image processing options into plural groups by the tone bit number;
(b) a second program for, in response to an execution instruction of a next image processing option after execution of a specific image processing option with regard to the input image data, causing the computer to refer to the result of classification stored by said first program and thereby determine whether the next image processing option is supposed to process image data of a greater tone bit number than a tone bit number of image data processed by the specific image processing option; and
(c) a third program for causing the computer to prohibit execution of the next image processing option when it is determined by said second program that the next image processing option is supposed to process the image data of the greater tone bit number.

29. A computer program product in accordance with claim 28, wherein said computer program further comprising:
(d) a fourth program for causing the computer to display plural group switches respectively corresponding to the plural groups of classification stored by said first program, on a display unit; and
(e) a fifth program for, in response to an operator's operation command of activating one of the multiple group switches, causing the computer to display an image processing option switch for execution of an image processing option included in a group corresponding to the activated group switch, on the display unit,
wherein the execution instruction of the next image processing option is the operator's operation command of activating another group switch, which is different from a specific group switch corresponding to a specific group including the specific image processing option and said second program causes said computer to carry out the determination, based on another group corresponding to the activated another group switch.

30. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein the multiple image processing options are designed to process image data of different tone bit numbers expressible in each pixel,
said computer program comprising:
(a) a first program for causing a computer to store a result of classification of the multiple image processing options into plural groups by the tone bit number;
(b) a second program for causing the computer to display plural group switches respectively corresponding to the plural groups of classification stored by first program, on a display unit in a descending order of the tone bit numbers of the plural groups corresponding to the plural group switches; and
(c) a third program for, in response to an operator's operation command of activating one of the multiple group switches, causing the computer to display an image processing option switch for execution of an image processing option included in a group corresponding to the activated group switch, on the display unit.

31. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein the multiple image processing options are designed to process image data of different tone bit numbers expressible in each pixel,
said computer program comprising:
(a) a first program for causing a computer to store a result of classification of the multiple image processing options into plural groups by the tone bit number; and
(b) a second program for causing the computer to set an execution order of the at least two image processing options to be equivalent to a descending order of the tone bit numbers of the image data processed by the at least two image processing options, based on the result of classification stored by said first program.

32. A computer program product in accordance with claim 31, wherein said computer program further comprising:
(c) a third program for causing the computer to sequentially specify the at least two image processing options to be executed for the input image data, in response to an operator's operation instructions;
(d) a fourth program for, every time one image processing option is specified by said third program, causing the computer to obtain a parameter representing a retouch degree of the specified image processing option in response to the operator's operation command;
(e) a fifth program for, every time one image processing option is specified by said third program, causing the computer to add the specified image processing option with the corresponding parameter obtained by said forth program, to a retouch record file; and
(f) a sixth program for, every time one image processing option is specified by said third program, causing the computer to generate output image data as a retouch result, based on the input image data, the retouch record file, and the execution order set by said second program.

33. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein each of the multiple image processing options is designed to process image data of a preset tone bit number, which is expressible in each pixel and is equal to either of a first value and a second value that is smaller than the first value,
said computer program comprising:
(a) a first program for causing a computer to form a layer to make a result of an image processing option reflected on the input image data;
(b) a second program for causing the computer to specify a preset image processing option selected among the multiple image processing options with regard to the input image data, in response to an operator's operation instruction;
(c) a third program for causing the computer to determine whether the tone bit number of image data processed by the preset image processing option, which is specified by said second program, is equal to the first value or the second value;
(d) a fourth program for causing the computer to execute the preset image processing option with regard to the input image data, when it is determined by said third program that the tone bit number of the image data processed by the preset image processing option is equal to the first value;
(e) a fifth program for causing the computer to execute the preset image processing option with regard to the layer, when it is determined by said third program that the tone bit number of the image data processed by the preset image processing option is equal to the second value; and
(f) a sixth program for causing the computer to execute lay the layer upon the input image data to generate composite image data.

34. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein each of the multiple image processing options is designed to process image data of a preset tone bit number, which is expressible in each pixel and is equal to either of a first value and a second value that is smaller than the first value,
said computer program comprising:
(a) a first program for causing a computer to form multiple layers to make results of image processing options reflected on the input image data;
(b) a second program for causing the computer to specify a preset image processing option selected among the multiple image processing options with regard to the input image data, in response to an operator's operation instruction;
(c) a third program for causing the computer to determine whether the tone bit number of image data processed by the preset image processing option, which is specified by said second program, is equal to the first value or the second value;
(d) a fourth program for causing the computer to execute the preset image processing option with regard to a lower-most layer among the multiple layers, when it is determined by said third program that the tone bit number of the image data processed by the preset image processing option is equal to the first value;
(e) a fifth program for causing the computer to execute the preset image processing option with regard to a layer other than the lower-most layer among the multiple layers, when it is determined by said third program that the tone bit number of the image data processed by the preset image processing option is equal to the second value; and
(f) a sixth program for causing the computer to successively lay the multiple layers upon the input image data to generate composite image data.

35. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein the multiple image processing options are designed to process image data of different tone bit numbers expressible in each pixel,
said computer program comprising:
(a) a first program for causing a computer to form multiple layers to make results of image processing options reflected on the input image data;
(b) a second program for causing the computer to store information representing classification of the multiple image processing options into plural groups by the tone bit number, where the information relates the input image data to a specified group of a greatest tone bit number among the plural groups, while respectively relating the multiple layers to residual groups other than the specified group among the plural groups such that an upper layer corresponds to a smaller tone bit number;
(c) a third program for causing the computer to specify a preset image processing option selected among the multiple image processing options with regard to the input image data, in response to an operator's operation instruction;
(d) a fourth program for causing the computer to refer to the information stored by said second program and selecting an execution object of the preset image processing specified by said a third program among the input image data and the multiple layers;
(e) a fifth program for causing the computer to execute the preset image processing option specified by said a third program with regard to the selected one of the input image data and the multiple layers by said function (d); and
(f) a sixth program for causing the computer to successively lay the multiple layers upon the input image data to generate composite image data.

36. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein the multiple image processing options are designed to process image data of different tone bit numbers expressible in each pixel,
said computer program comprising:
(a) a first program for causing a computer to form multiple layers to make results of image processing options reflected on the input image data;
(b) a second program for causing the computer to store information representing classification of the multiple image processing options into plural groups by the tone bit number, where the information respectively relates the multiple layers to the plural groups such that an upper layer corresponds to a smaller tone bit number;
(c) a third program for causing the computer to specify a preset image processing option selected among the multiple image processing options with regard to the input image data, in response to an operator's operation instruction;
(d) a fourth program for causing the computer to refer to the information stored by said second program and selecting an execution object of the preset image processing specified by said a third program among the multiple layers formed by said first program;
(e) a fifth program for causing the computer to execute the preset image processing option specified by said a third program with regard to the selected one of the multiple layers by said fourth program; and
(f) a sixth program for causing the computer to successively lay the multiple layers upon the input image data to generate composite image data.

37. A computer program product that is used to sequentially execute at least two image processing options, which are selected among multiple image processing options provided in advance, with regard to input image data and thereby retouch the input image data,
said computer program product comprising:
a computer readable medium; and
a computer program that is stored in said computer readable medium,
wherein the multiple image processing options are designed to process image data of different tone bit numbers expressible in each pixel,
said computer program comprising:
(a) a first program for causing a computer to store a result of classification of the multiple image processing options into plural groups by the tone bit number; and
(b) a second program for causing the computer to executing the at least two image processing options in a preset order with regard to the input image data, based on the tone bit numbers of the respective image processing options and the result of classification stored by first program.
